(19) United States
(12) Patent Application Publication
(10) Pub. No.: US 2017/0078509 A1
(43) Pub. Date: Mar. 16, 2017

(54) INFORMATION PROCESSING SYSTEM AND INFORMATION PROCESSING METHOD

(71) Applicant: Kohsuke NAMIHIRA, Tokyo (JP)

(72) Inventor: Kohsuke NAMIHIRA, Tokyo (JP)

(73) Assignee: Ricoh Company, Ltd., Tokyo (JP)

(21) Appl. No.: 15/123,705

(22) PCT Filed: Mar. 12, 2015
(86) PCT No.: PCT/JP2015/058152

§ 371 Date: Sep. 6, 2016

(30) Foreign Application Priority Data
Mar. 17, 2014 (JP) 2014-054035

(51) Int. Cl. H04N 1/00; G06F 9/445; H04N 1/32

(52) U.S. Cl. CPC H04N 1/00933; H04N 1/32032; H04N 1/00204; H04N 1/00344; G06F 8/67; H04N 2201/0094; H04N 2201/0039

(57) ABSTRACT

An information processing system includes electronic devices and a service providing system constituted by information processing devices. The information processing system includes an information operating unit configured to send, from the service providing system to a user terminal, connection information for connecting to an electronic device relevant to a request for an operation, and an instruction for causing the electronic device to execute a process based on the request, when the request is received by the service providing system from the user terminal; and an information processing unit configured to perform a process of synchronizing information at the electronic device by accessing the service providing system according to the instruction from the user terminal, when the user terminal sends the instruction, which has been sent by the information operating unit, to the electronic device based on the connection information sent by the information operating unit.

### TECHNICAL FIELD

The present invention relates to an information processing system and an information processing method.

### BACKGROUND ART

There is conventionally known a mechanism in a client server type system, in which the update information, which is used when updating synchronization information, is quickly applied to the respective terminals, while suppressing the load of the network and the terminals, when constructing an information synchronization system by using a request-response type communication protocol in the Internet environment (see, for example, Patent Document 1).

For example, there are cases where an electronic device such as an image forming apparatus provides a service, to a user, by using information managed by a server device. In an information processing system, where the server device cannot access an electronic device due to the network mode, the electronic device accesses the server device to acquire information.

However, in an information processing system in which the electronic device accesses a server device to acquire information, there has been a problem in that the update of information performed in the server device cannot be detected, until the electronic device accesses the server device. Note that when the intervals of accessing the service device from the electronic device (polling intervals) are reduced for the purpose of reducing the time until the update of information is detected, the network load increases as a result of reducing the intervals.

The above problem similarly occurs when the server device gives an instruction to perform a process to the electronic device, in an information processing system in which a service providing system such as the server device cannot access the electronic device due to the network mode.

Patent Document 1: Japanese Laid-Open Patent Application No. 2002-33787

### DISCLOSURE OF INVENTION

The present invention has been made in view of the above-described problems, and it is an object of at least one embodiment of the present invention to provide an information processing system and an information processing method by which the service providing system can give an instruction to perform a process to the electronic device.

An aspect of the present invention provides an information processing system including a plurality of electronic devices and a service providing system constituted by one or more information processing devices, the information processing system including an information operating unit configured to send, from the service providing system to a user terminal, connection information for connecting to one of the plurality of electronic devices relevant to a request for a predetermined information operation, and a process instruction for causing the one of the plurality of electronic devices to execute a process based on the request for the predetermined information operation, when the request for the predetermined information operation is received by the service providing system from the user terminal; and an information processing unit configured to perform a process of synchronizing information at the one of the plurality of electronic devices by accessing the service providing system according to the process instruction from the user terminal, when the user terminal sends the process instruction, which has been sent by the information operating unit, to the one of the plurality of electronic devices based on the connection information sent by the information operating unit.

An aspect of the present invention provides an information processing system including a plurality of electronic devices and a service providing system constituted by one or more information processing devices, the information processing system including an information operating unit configured to send, from the service providing system to a user terminal, connection information for connecting to one of the plurality of electronic devices relevant to a request for a predetermined information operation, a process instruction for causing the one of the plurality of electronic devices to execute a process based on the request for the predetermined information operation, and association information associated with the process, when the request for the predetermined information operation is received by the service providing system from the user terminal; and an information processing unit configured to perform a process at the one of the plurality of electronic devices according to the process instruction by using the association information, when the user terminal sends the process instruction and the association information, which have been sent by the information operating unit, to the one of the plurality of electronic devices based on the connection information sent by the information operating unit.

An aspect of the present invention provides an information processing method executed by an information processing system including a plurality of electronic devices, and a service providing system constituted by one or more information processing devices, the information processing method including sending, from the service providing system to a user terminal, connection information for connecting to one of the plurality of electronic devices relevant to a request for a predetermined information operation, and a process instruction for causing the one of the plurality of electronic devices to execute a process based on the request for the predetermined information operation, when the request for the predetermined information operation is received by the service providing system from the user terminal; and performing a process of synchronizing information at the one of the plurality of electronic devices by accessing the service providing system according to the process instruction from the user terminal, when the user terminal sends the process instruction, which has been sent at the sending, to the one of the plurality of electronic devices based on the connection information sent at the sending.

### BRIEF DESCRIPTION OF DRAWINGS

FIG. 1 is a configuration diagram of an example of an information processing system according to a first embodiment;

FIG. 2 is a hardware configuration diagram of an example of a computer;

FIG. 3 illustrates a hardware configuration of an example of an image forming apparatus according to an embodiment;

FIG. 4 is a process block diagram of an example of the information processing system according to the first embodiment;

FIG. 5 is a configuration diagram of an example of a job log;

FIGS. 6A through 6D are configuration diagrams of examples of tables managed by a scan setting storage unit;

FIGS. 7A through 7D are configuration diagrams of examples of tables managed by a company information storage unit;

FIG. 8 is a sequence diagram illustrating an example of an overall process;

FIG. 9 is a sequence diagram illustrating an example of the phase of registering a device;

FIG. 10 is a sequence diagram illustrating an example of the phase of making a scan setting;

FIG. 11 is an image diagram of an example of a profile setting screen;

FIG. 12 is an image diagram of an example of a group setting screen;

FIG. 13 is an image diagram of an example of a project setting screen for making basic settings;

FIG. 14 is an image diagram of an example of a project setting screen for setting a file format, etc.;

FIG. 15 is an image diagram of an example of a profile assignment screen;

FIG. 16 is a sequence diagram illustrating an example of a process of synchronizing scan settings;

FIG. 17 is an image diagram of an example of a profile update screen;

FIG. 18 is a configuration diagram of an example of a response from a service providing system to a user terminal;

FIG. 19 is a configuration diagram of an example of a request from the user terminal to the image forming apparatus;

FIG. 20 is a sequence diagram illustrating an example of a process of synchronizing job logs;

FIG. 21 is an image diagram of an example of a job log view screen;

FIG. 22 is a sequence diagram illustrating an example of a process of registering a license;

FIG. 23 is an image diagram of an example of a license registration screen;

FIG. 24 is a sequence diagram illustrating another example of a process of synchronizing the scan setting;

FIG. 25 is a configuration diagram of an example of a response from the service providing system to the user terminal; and

FIG. 26 is a configuration diagram of an example of a request from the user terminal to the image forming apparatus.

### DESCRIPTION OF THE REFERENCE NUMBERS

1 information processing system
11 image forming apparatus
12 user terminal
13 service providing system
21 scan application server device
22 company management server device
23 asynchronous conversion process server device
31 company information DB (database)
32 job log management DB
33 scan setting management DB
34 share file storage
51 scan application
52 scan setting storage unit
53 job log storage unit
54 company management module
55 asynchronous conversion process module
56 company information storage unit
57 share file storage unit
58, 62 Web API (Application Programming Interface)
61 embedded application
63 Web browser
100 computer
101 input device
102 display device
103 external I/F
103a recording medium
104 RAM
105 ROM
106 CPU
107 communication I/F
108 HDD
201 controller
202 operation panel
203 external I/F
203a recording medium
204 communication I/F
205 printer
206 scanner
211 CPU
212 RAM
213 ROM
214 NVRAM
215 HDD
B bus
N1 through N3 network

### BEST MODE FOR CARRYING OUT THE INVENTION

Embodiments of the present invention are described below with reference to the accompanying drawings.

### First Embodiment

### System Configuration

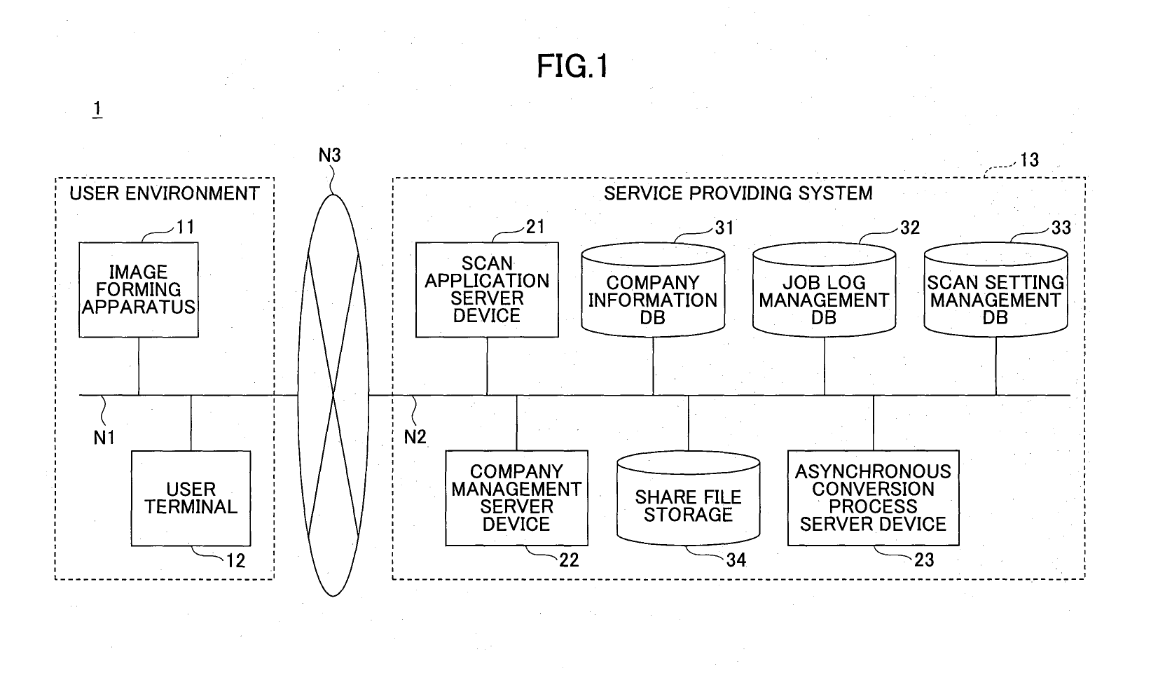

FIG. 1 is a configuration diagram of an example of an information processing system according to a first embodiment. An information processing system 1 illustrated in FIG. 1 includes, for example, a network N1 of a user environment, a network N2 of a service providing system 13 that is typically a cloud service, and a network N3 such as the Internet.

To the network N1, one or more image forming apparatuses 11 and one or more user terminals 12 are connected. Note that although not illustrated, between the network N1 and the network N3, a device such as a firewall for detecting and blocking unauthorized accesses, is provided.

The image forming apparatus 11 is a device (electronic device) having an image forming function, such as a multifunction peripheral. The image forming apparatus 11 includes a unit for wireless communication and a unit for wired communication. The image forming apparatus 11 is a device for executing scanning (reading) of an original document, such as a multifunction peripheral and a scanner.

The user terminal 12 may be realized by, for example, an information processing device in which a general-purpose OS is installed. The user terminal 12 includes a unit for wireless communication and a unit for wired communication. The user terminal 12 is a terminal that can be operated by the user, such as a tablet PC, a notebook PC, a smartphone, and a mobile phone.

Furthermore, to the network N2, a scan application server device 21, a company management server device 22, an asynchronous conversion process server device 23, a company information DB (database) 31, a job log management DB 32, a scan setting management DB 33, and a share file storage 34, are connected. Note that between the network N2 and the network N3, a device such as an access control device for detecting and blocking unauthorized accesses, may be provided.

The scan application server device 21 exchanges information with the image forming apparatus 11 and the user terminal 12 via a web API. Furthermore, the scan application server device 21 requests the company management server device 22 and the asynchronous conversion process server device 23 to perform a process, according to contents of a job. Furthermore, the company management server device 22 manages the information of a company using the service providing system 13, and provides the information of a company using the service providing system 13 in response to an inquiry from the scan application server device 21, etc.

The asynchronous conversion process server device 23 performs, in an asynchronous manner, a conversion process and mail transmission, requested from the scan application server device 21, etc. Note that the mail transmission may include transmitting web mail, other than electronic mail. The company information DB 31 manages information of companies and users that use the service providing system 13.

The job log management DB 32 manages the log of a job executed by the user. The scan setting management DB 33 manages settings for scanning with the image forming apparatus 11 and settings for performing mail transmission. The share file storage 34 is a storage for storing files (a scanned image file and a text file obtained after OCR, etc.) used by the service providing system 13.

The scan application server device 21, the company management server device 22, and the asynchronous conversion process server device 23 are realized by one or more information processing devices. Furthermore, the scan application server device 21, the company management server device 22, and the asynchronous conversion process server device 23 may be realized by being integrated into a single information processing device, or by being distributed across a plurality of information processing devices.

Similarly, the company information DB 31, the job log management DB 32, the scan setting management DB 33, and the share file storage 34 are realized by one or more information processing devices. Furthermore, the company information DB 31, the job log management DB 32, the scan setting management DB 33, and the share file storage 34 may be realized by being integrated into a single information processing device, or by being distributed across a plurality of information processing devices. Furthermore, some of the server devices and the DBs included in the service providing system 13 may be provided outside the network N2. Furthermore, the DBs included in the service providing system 13 may be devices for storing files provided by a vendor such as an online storage. The configuration of the information processing system 1 of FIG. 1 is one example, and may have other configurations.

<Hardware Configuration>

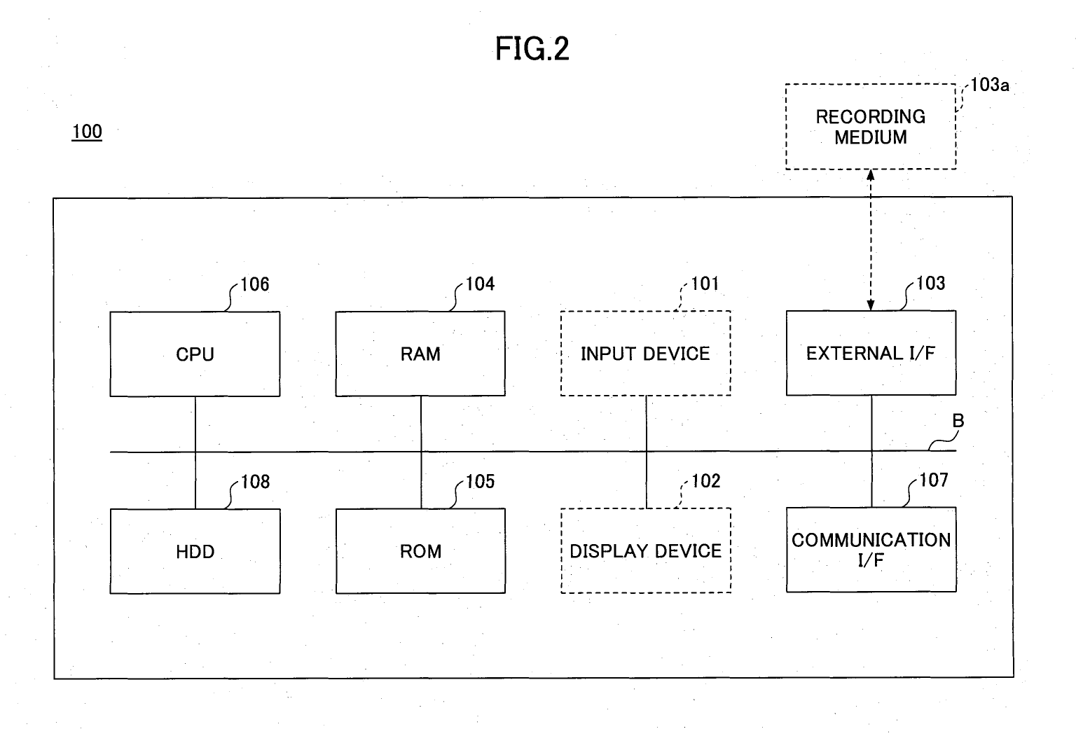

The user terminal 12, the scan application server device 21, the company management server device 22, and the asynchronous conversion process server device 23 of FIG. 1 may be realized by a computer having a hardware configuration as illustrated in, for example, FIG. 2. Furthermore, the company information DB 31, the job log management DB 32, the scan setting management DB 33, and the share file storage 34 are also realized by a computer having a hardware configuration as illustrated in, for example, FIG. 2.

FIG. 2 is a hardware configuration diagram of an example of a computer. A computer 100 illustrated in FIG. 2 includes an input device 101, a display device 102, an external I/F 103, a RAM 104, a ROM 105, a CPU 106, a communication I/F 107, and a HDD 108, which are interconnected by a bus B. Note that the input device 101 and the display device 102 may have a mode of being connected and used when necessary.

The input device 101 includes a keyboard, a mouse, and a touch panel, which are used by the user for inputting various operation signals. The display device 102 includes a display, and displays processing results by the computer 100.

The communication I/F 107 is an interface for connecting the computer 100 to the network N1 or the network N2. Accordingly, the computer 100 is able to perform data communication via the communication I/F 107.

Furthermore, the HDD 108 is an example of a non-volatile storage device for storing programs and data. The stored programs and data include an OS that is the basic software for controlling the entire computer 100, and application software for providing various functions in the OS. Note that the computer 100 may use a drive device (for example, a solid state drive: SSD) using a flash memory as the storage medium, instead of the HDD 108.

The HDD 108 manages the stored programs and data by a predetermined file system and/or a DB. The external I/F 103 is an interface between the computer 100 and an external device. An example of the external device is a recording medium 103a.

Accordingly, the computer 100 is able to read and/or write in the recording medium 103a via the external I/F 103. Examples of the recording medium 103a are a flexible disk, a CD, a DVD, an SD memory card, and a USB memory.

The ROM 105 is a non-volatile semiconductor memory (storage device) that can store programs and data even after the power is turned off. The ROM 105 stores programs and data such as a BIOS that is executed when the computer 100 is activated, OS settings, and network settings. The RAM 104 is a volatile semiconductor memory (storage device) for temporarily storing programs and data.

The CPU 106 is a processor for controlling the entire computer 100 and realizing functions of the computer 100, by loading the programs and data from the storage devices such as the ROM 105 and the HDD 108, into the RAM 104, and executing processes.

The user terminal 12, the scan application server device 21, the company management server device 22, and the asynchronous conversion process server device 23 are able to realize various processes described below, by the hardware configuration of the computer 100.

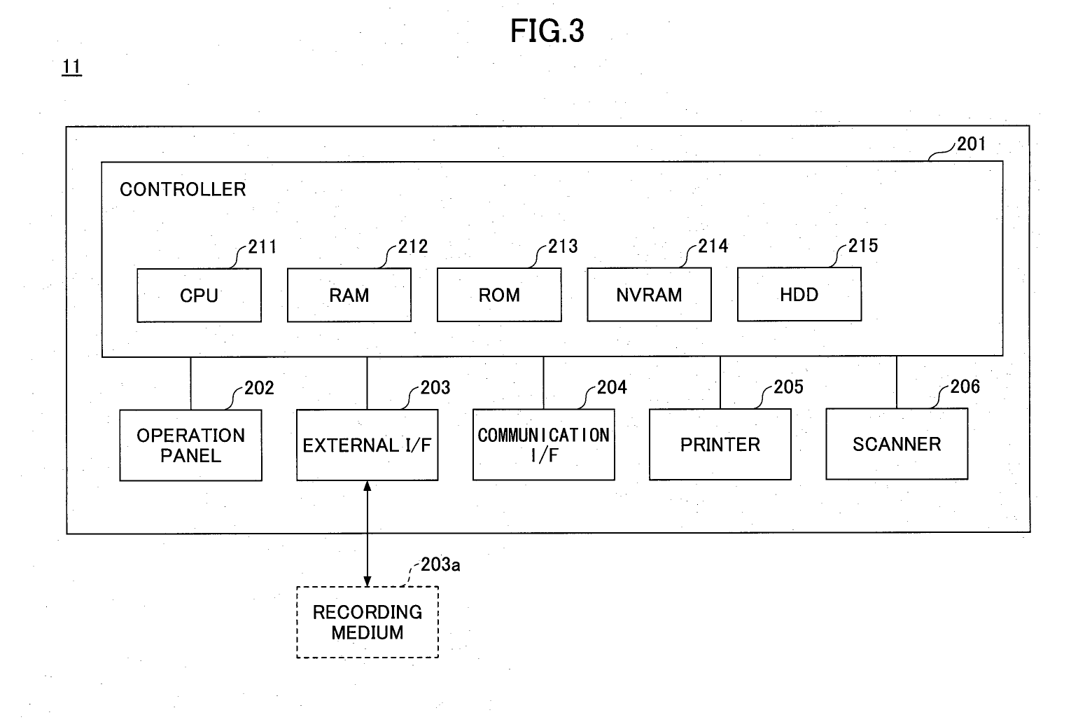

The image forming apparatus 11 illustrated in FIG. 1 is realized by a computer having a hardware configuration, for example, as illustrated in FIG. 3. FIG. 3 illustrates a hardware configuration of an example of the image forming apparatus 11 according to the present embodiment. The image forming apparatus 11 illustrated in FIG. 3 includes a controller 201, an operation panel 202, an external I/F 203, a communication I/F 204, a printer 205, and a scanner 206.

The controller 201 includes a CPU 211, a RAM 212, a ROM 213, a NVRAM 214, and a HDD 215. The ROM 213 stores various programs and data. The RAM 212 temporarily stores programs and data. The NVRAM 214 stores, for example, setting information. Furthermore, the HDD 215 stores various programs and data.

The CPU 211 controls the entire image forming apparatus 11 and realizes functions of the image forming apparatus 11, by loading the programs, data, and setting information, from the ROM 213, the NVRAM 214, and the HDD 215, into the RAM 212, and executing processes.

The operation panel 202 includes an input unit for receiving input from a user, and a display unit for displaying information. The external I/F 203 is an interface between the image forming apparatus 11 and an external device. An example of the external device is a recording medium 203a. Accordingly, the image forming apparatus 11 is able to read and/or write in the recording medium 203a via the external I/F 203. Examples of the recording medium 203a are an IC card, a flexible disk, a CD, a DVD, an SD memory card, and a USB memory.

The communication I/F 204 is an interface that connects the image forming apparatus 11 to the network N1. Accordingly, the image forming apparatus 11 is able to perform data communication via the communication I/F 204. The printer 205 is a printing device for printing print data onto a sheet. The scanner 206 is a reading device for reading image data (electronic data) from an original document.

<Software Configuration>

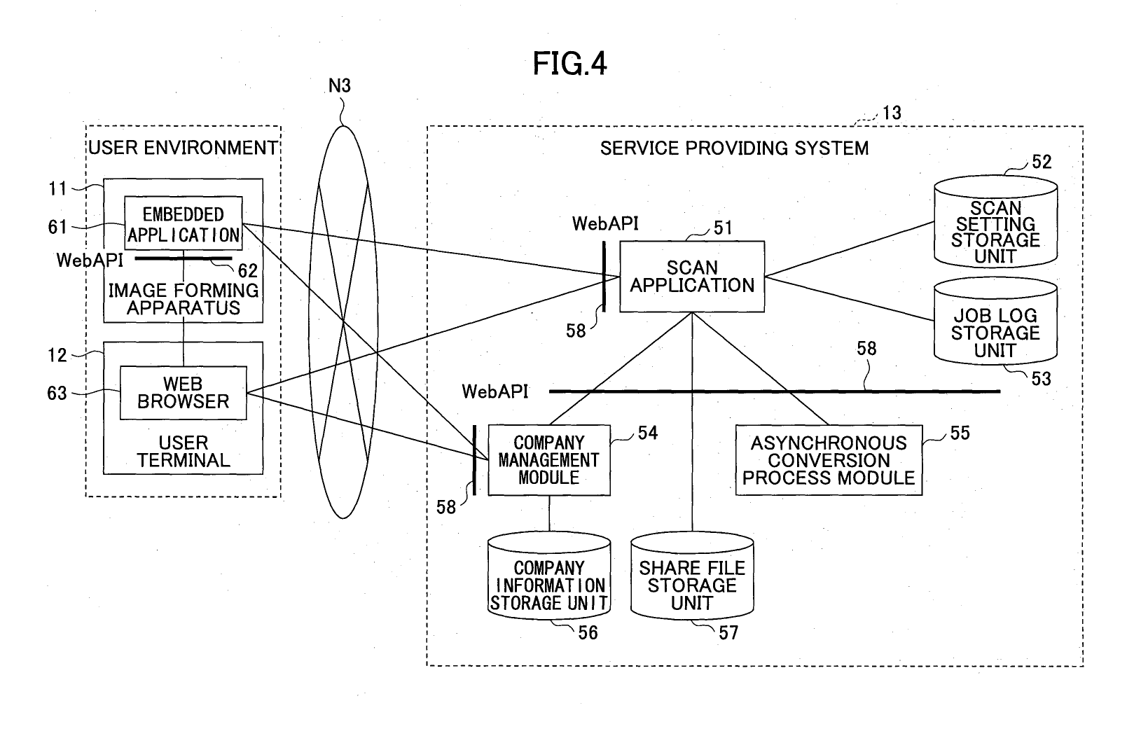

The information processing system 1 according to the first embodiment is realized by process blocks including modules and storage units, for example, as illustrated in FIG. 4. FIG. 4 is a process block diagram of an example of the information processing system 1 according to the first embodiment.

In the image forming apparatus 11, an embedded application 61 operates, which is a module. The embedded application 61 performs communication with the service providing system 13 via a web API (Application Programming Interface) 58. For example, the embedded application 61 acquires a scan setting, registers a job, and synchronizes a job log, by communicating with a scan application 51.

In the user terminal 12, a web browser 63 operates. The web browser 63 performs communication with the service providing system 13 via the web API 58. Furthermore, the web browser 63 performs communication with the embedded application 61 via a web API 62. By communicating with the embedded application 61, the web browser 63 sends, to the image forming apparatus 11, instructions from the service providing system 13, such as to acquire a scan setting and to synchronize a job log.

The service providing system 13 includes a scan application 51, a scan setting storage unit 52, a job log storage unit 53, a company management module 54, an asynchronous conversion process module 55, a company information storage unit 56, and a share file storage unit 57.

The scan application 51 provides a scan setting screen to the user, and stores the scan setting set in the scan setting screen, in the scan setting storage unit 52. Furthermore, the scan application 51 exchanges information with the embedded application 61 of the image forming apparatus 11 and the web browser 63 of the user terminal 12 via the web API 58. For example, the scan application 51 returns a scan setting in response to a request for a scan setting from the embedded application 61. Furthermore, the scan application 51 has the responsibility of connecting the respective modules with each other.

The scan application 51 requests, for example, the asynchronous conversion process module 55 to perform a process, according to contents of job registered from the embedded application 61 of the image forming apparatus 11. Furthermore, the scan application 51 stores the job log in the job log storage unit 53. The company management module 54 manages information of companies and users using the service providing system 13, and provides the information of companies and users using the service providing system 13 in response to an inquiry from the respective modules.

The asynchronous conversion process module 55 is a processing unit for performing a process requested from the scan application 51 in an asynchronous manner. The asynchronous conversion process module 55 performs a process according t contents of a job such as a conversion process and mail transmission, requested from the scan application 51.

The scan setting storage unit 52 is a storage unit for managing settings for scanning with the image forming apparatus 11 and settings for performing mail transmission. The job log storage unit 53 is a storage unit for managing a log of a job executed by a user. The job log storage unit 53 is used when the administrator or the user refers to execution (process) result history of a job.

The company information storage unit 56 is a storage unit for storing information of companies and users using the service providing system 13. The share file storage unit 57 is a storage unit for storing files, etc., used by the service providing system 13.

The web API 58 is an interface defined in advance, which is provided for receiving requests, and is constituted by, for example, functions and classes. The image forming apparatus 11 and the user terminal 12 are able to use functions of the scan application 51, within a range that is open to the public by the web API 58. Furthermore, the scan application 51 is able to use functions of the company management module 54 and the asynchronous conversion process module 55, within a range that is open to the public by the web API 58.

The classification mode of the process blocks of the information processing system 1 of FIG. 4 is one example; it is not essential that the process blocks are classified as illustrated in FIG. 4. As long as processes of the information processing system 1 according to the first embodiment may be performed, the classification illustrated in FIG. 4 is not particularly limited.

### <Data Configuration>

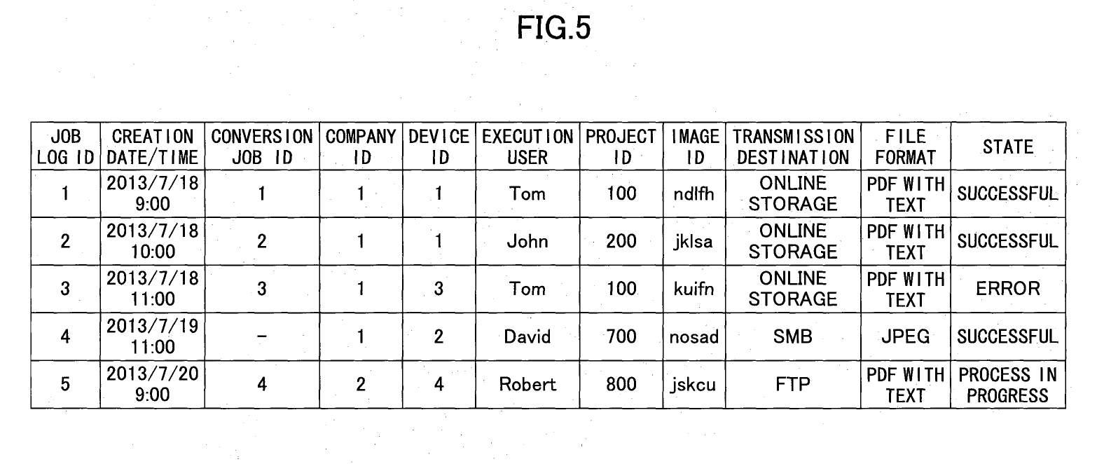

FIG. 5 is a configuration diagram of an example of a job log. The job log includes a job log ID, a creation date/time, a conversion job ID, a company ID, a device ID, an execution user, a project ID, an image ID, a transmission destination, a file format, and a state, as items.

The job log ID is information for identifying a job log. The creation date/time is the date/time when the job log was created. The conversion ID is information for identifying job information managed by the asynchronous conversion process module 55. The company ID is information for identifying an organization or a group such as a company or a department. Note that the company ID is not limited to the term “company”. The device ID is information identifying the image forming apparatus 11, etc., that has registered the job.

The execution user is information identifying the user who registered the job by operating the image forming apparatus 11, etc. The project ID is information identifying a project described below. The image ID is information identifying a file such as an image file that is the target of the process. The transmission destination is information expressing the transmission destination of the file. The file format is information expressing the format of the file. The state is information expressing the process result (process in progress/successful/error (unsuccessful), etc.) of the job

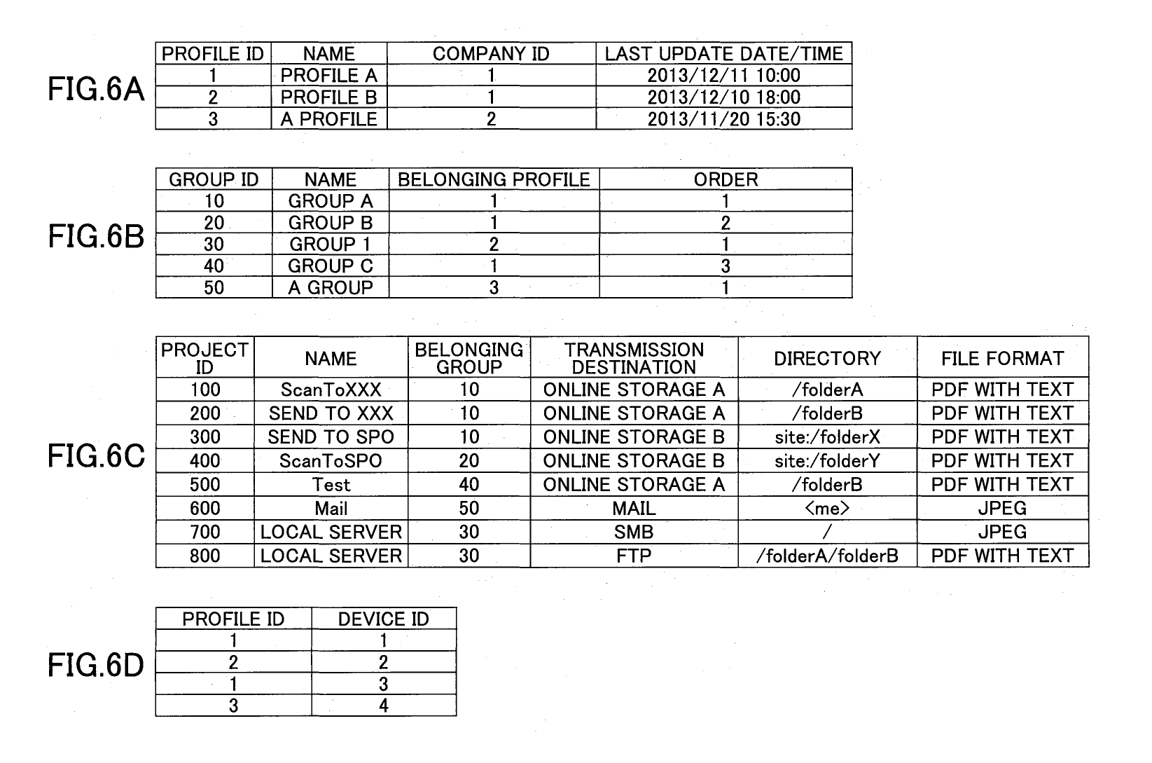

FIGS. 6A through 6D are configuration diagrams of examples of tables managed by the scan setting storage unit 52. FIG. 6A indicates a profile table, FIG. 6B indicates a group table, FIG. 6C indicates a project table, and FIG. 6D indicates a device setting table.

The project table is for the user to set the contents of a job that is executable from the image forming apparatus 11, as a project. A project may be a job for executing scanning and sending the image data obtained by the scanning to a mail address of the execution user or another user, a job for executing scanning and sending the image data obtained by the scanning to a local server or an online storage, etc.

The project table of FIG. 6A includes a project ID, a name, a belonging group, a transmission destination, a directory, and a file format, as items. Note that the transmission destination and the file format are the same as those of the job log in FIG. 5, and therefore descriptions thereof are omitted. The project ID is information for identifying a project. The name is an example of information for the user to identify a project. The belonging group is a group ID of the group to which the project belongs. One or more projects may belong to a group. The directory expresses the directory of the transmission destination of the file.

The group table is for setting a group. The group table in FIG. 6B includes a group ID, a name, a belonging profile, and an order, as items. The group ID is information for identifying a group. The name is an example of information for the user to identify a group. The belonging profile is a profile ID of the profile to which the group belongs. The order expresses the rank order at which the group is expressed in the profile. One or more groups may belong to a profile.

The profile table is for setting a profile. The profile table in FIG. 6A includes a profile ID, a name, a company ID, and a last update date/time, as items. The profile ID is information for identifying a profile. The name is an example of information for the user to identify a profile. Note that the company ID is the same as that of the job log in FIG. 5. The last update date/time is information expressing the last date/time when the profile table was updated. An electronic device such as the image forming apparatus 11 may be associated with one profile.

The device setting table is for associating a profile with a device. The device setting table of FIG. 6D includes a profile ID and a device ID as items. By the device setting table, an electronic device such as the image forming apparatus 11 is associated with one profile.

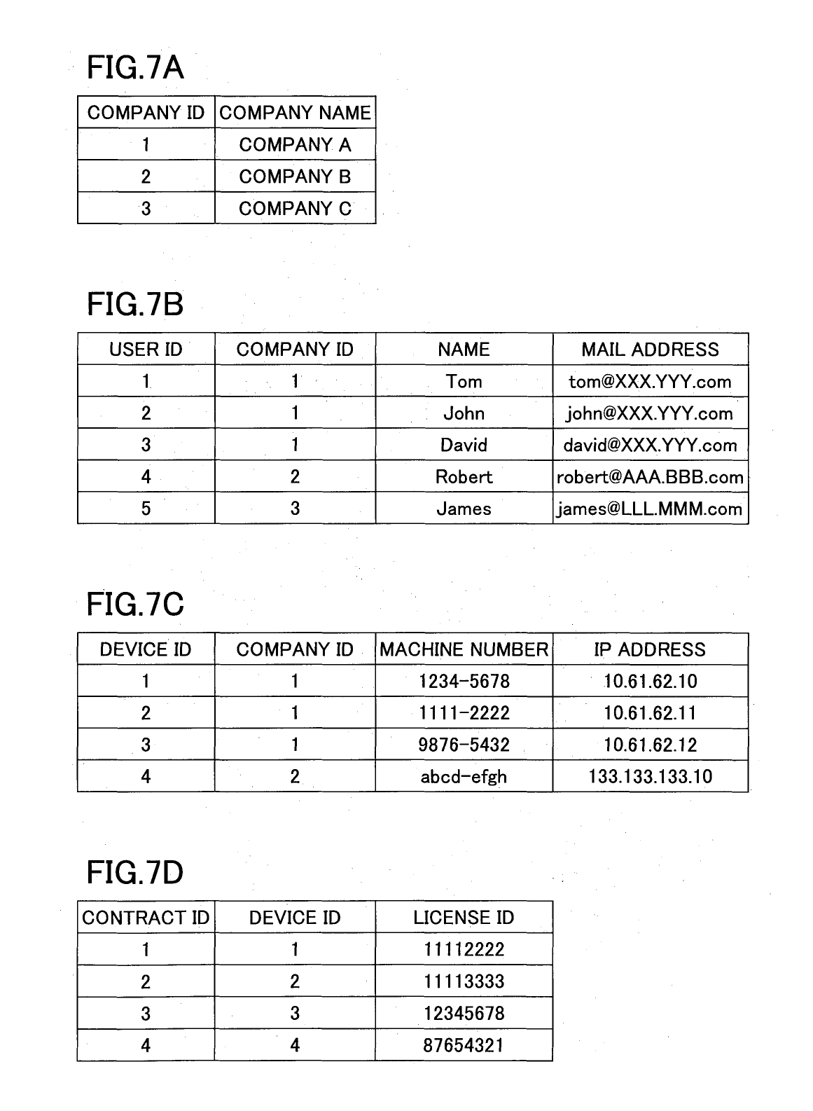

FIGS. 7A through 7D are configuration diagrams of examples of tables managed by the company information storage unit 56. FIG. 7A indicates a company table, FIG. 7B indicates a user table, FIG. 7C indicates a device table, and FIG. 7D indicates a contract table.

The company table of FIG. 7A includes a company ID and a company name as items. The company name is an example of information for the user to identify a company. By the company table, the company ID is associated with a company name.

The user table of FIG. 7B includes a user ID, a company ID, a name, and a mail address as items. The user ID and the name are information for identifying a user. The mail address is the mail address of the user. By the user table, the user is associated with a company.

The device table of FIG. 7C includes a device ID, a company ID, a machine number, and an IP address, as items. The machine number is an example of unique information that can be acquired from an electronic device such as the image forming apparatus 11. The IP address is an example of a link to an electronic device such as the image forming apparatus 11. The link to an electronic device may include a path. An electronic device such as the image forming apparatus 11 is associated with a company by the device table.

Furthermore, the contract table of FIG. 7D includes a contract ID, a device ID, and a license ID, as items. The contract ID is information for identifying a contract. The license ID is information for identifying a license. By the contract table, an electronic device such as the image forming apparatus 11 is associated with a license.

### <Details of Process>

<<Overall Sequence>>

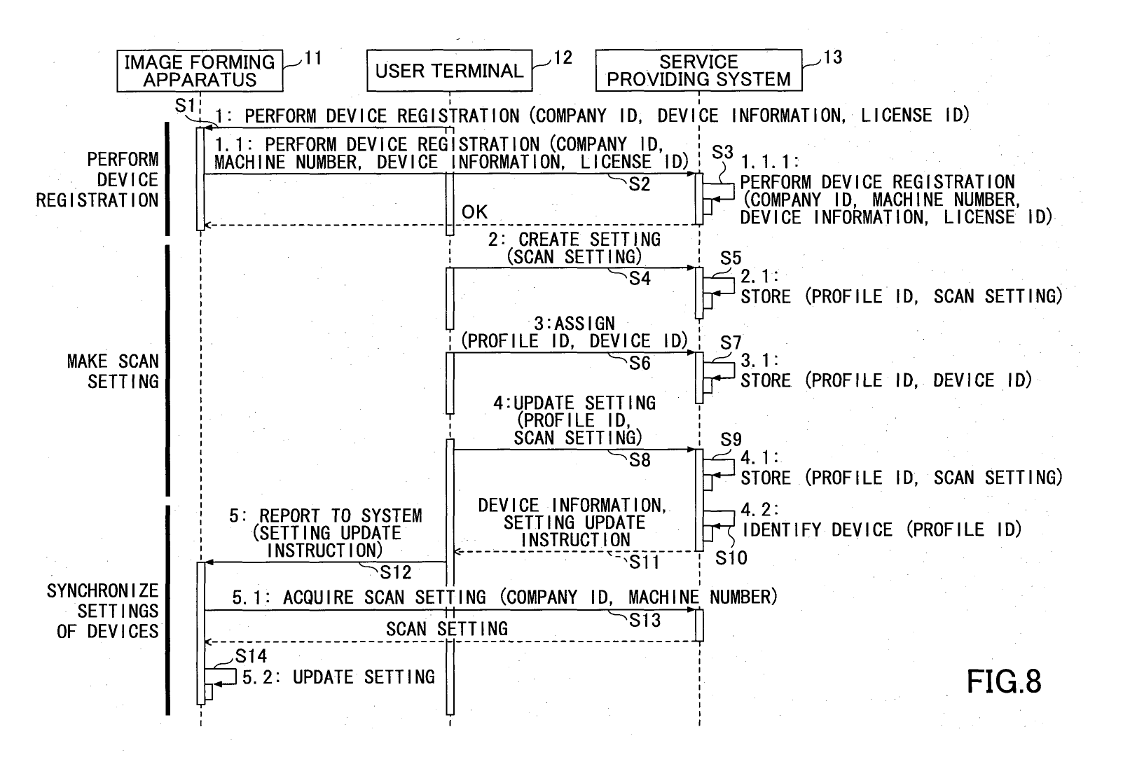

FIG. 8 is a sequence diagram illustrating an example of an overall process. The sequence diagram of FIG. 8 includes a phase of registering a device, a phase of making a scan setting, and a phase of synchronizing settings of devices.

The phase of registering a device is performed as an introduction of a device setting for the image forming apparatus 11 to use the service providing system 13 from the user terminal 12. The phase of registering a device corresponds to steps S1 through S3 in the sequence diagram of FIG. 8.

The phase of making a scan setting is performed for the image forming apparatus 11 to performing scanning from the user terminal 12. The phase of making a scan setting corresponds to steps S4 through S9.

The phase of synchronizing settings of devices is performed for applying the scan setting set in the service providing system 13, to the image forming apparatus 11. Note that the phase of synchronizing settings of devices corresponds to steps S10 through S14.

In step S1, an administrator instructs the image forming apparatus 11 to perform device registration, by specifying a company ID, device information, and a license ID from the user terminal 12. In step S2, the image forming apparatus 11 requests the service providing system 13 to perform device registration, by specifying the company ID, the machine number, the device information, and the license ID. In step S3, the service providing system 13 performs device registration by using the company ID, the machine number, the device information, and the license ID specified by the image forming apparatus 11. Note that details of the phase of making a scan setting indicated in steps S1 through S3 are described below.

In step S4, the administrator instructs the service providing system 13 to create a scan setting for the image forming apparatus 11 to performing scanning, by specifying a scan setting, from the user terminal 12. In step S5, the service providing system 13 stores the scan setting in association with a profile ID.

In step S6, the administrator instructs, the service providing system 13 to perform assignment, by specifying, a profile ID and a device ID, from the user terminal 12. In step S7, the service providing system 13 stores the profile ID and the device ID in association with each other.

In step S8, the administrator instructs the service providing system 13 to update the scan setting, by specifying the profile ID and a scan setting, from the user terminal 12. In step S9, the service providing system 13 stores the scan setting in association with the profile ID. Note that details of the phase of making a scan setting indicated in steps S4 through S9 are described below.

In step S10, the service providing system 13 refers to the device setting table of FIG. 6, and identifies the device ID associated with the profile ID. In step S11, the service providing system 13 returns device information and a setting update instruction, to the user terminal 12.

In step S12, the user terminal 12 sends the setting update instruction to the image forming apparatus 11 corresponding to the device information returned from the service providing system 13. Note that the device information includes an IP address and a path, which are an example of a link to the image forming apparatus 11.

In step S13, the image forming apparatus 11 requests the service providing system 13 to acquire a scan setting, by specifying the company ID and the machine number, according to the setting update instruction. The service providing system 13 identifies the profile ID from the company ID and the device ID corresponding to the machine number, and returns the scan setting associated with the profile ID, to the image forming apparatus 11. In step S14, the image forming apparatus 11 updates the scan setting stored in itself by the scan setting returned from the service providing system 13.

As described above, the image forming apparatus 11 is able to synchronize the scan setting with the scan setting stored in the scan setting storage unit 52, by receiving a setting update instruction from the service providing system 13 via the user terminal 12, at a timing when a scan setting is made from the user terminal 12 by the administrator.

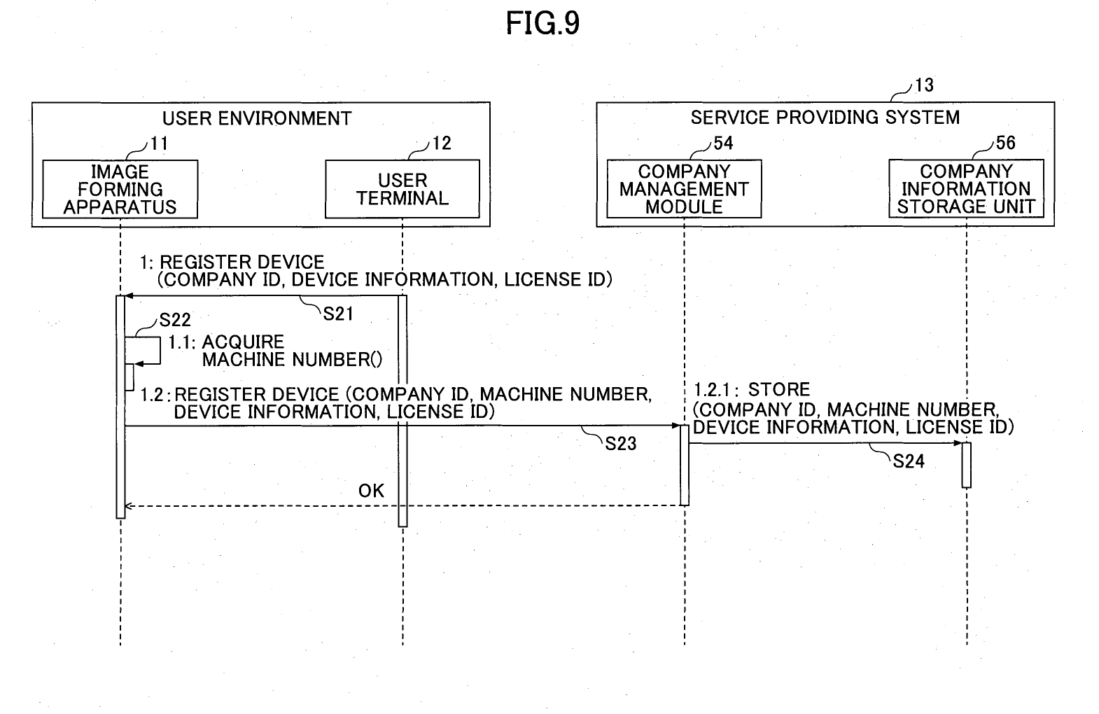

FIG. 9 is a sequence diagram illustrating an example of the phase of registering a device. In step S21, the administrator accesses the image forming apparatus 11 from the user terminal 12. Then, the administrator instructs the image forming apparatus 11 to register the device, by specifying the company ID, the device information, and a license ID, from the user terminal 12. Note that the company ID and the license ID are issued at the time of the contract with the service providing system 13. The device information includes an IP address and a path, which are an example of a link to the image forming apparatus 11.

In step S22, the image forming apparatus 11 acquires, for example, a machine number that is unique information that can be acquired from itself. In step S23, the image forming apparatus 11 requests the company management module 54 of the service providing system 13 to register, the device via the web API 58, by specifying the company ID, the machine number, and the license ID.

In step S24, the company management module 54 registers the device in the device table in the company information storage unit 56 of FIG. 7C, by using the company ID, the machine number, the device information, and the license ID specified by the image forming apparatus 11.

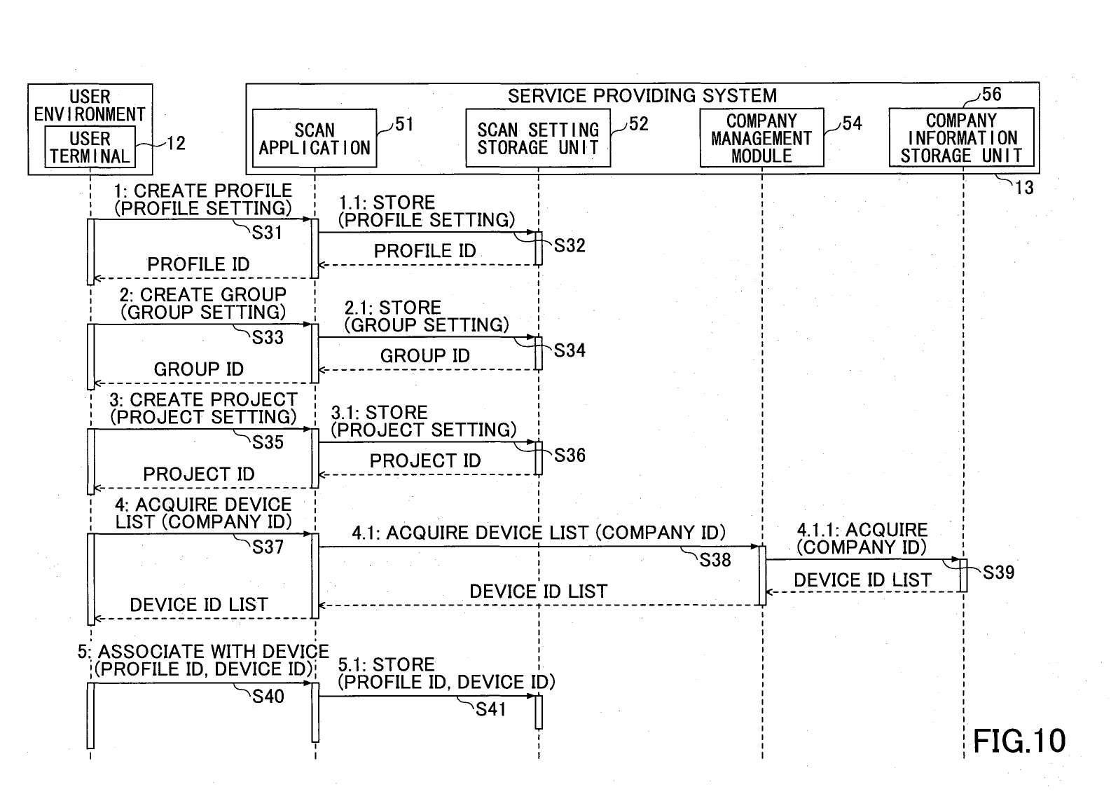

FIG. 10 is a sequence diagram illustrating an example of the phase of making a scan setting. FIG. 10 indicates an example that is implemented as the administrator operates the web browser 63 of the user terminal 12.

By the phase of making the scan setting of FIG. 10, values are stored in the profile table, the group table, the project table, and the device setting table in the scan setting storage unit 52 illustrated in FIGS. 6A through 6D.

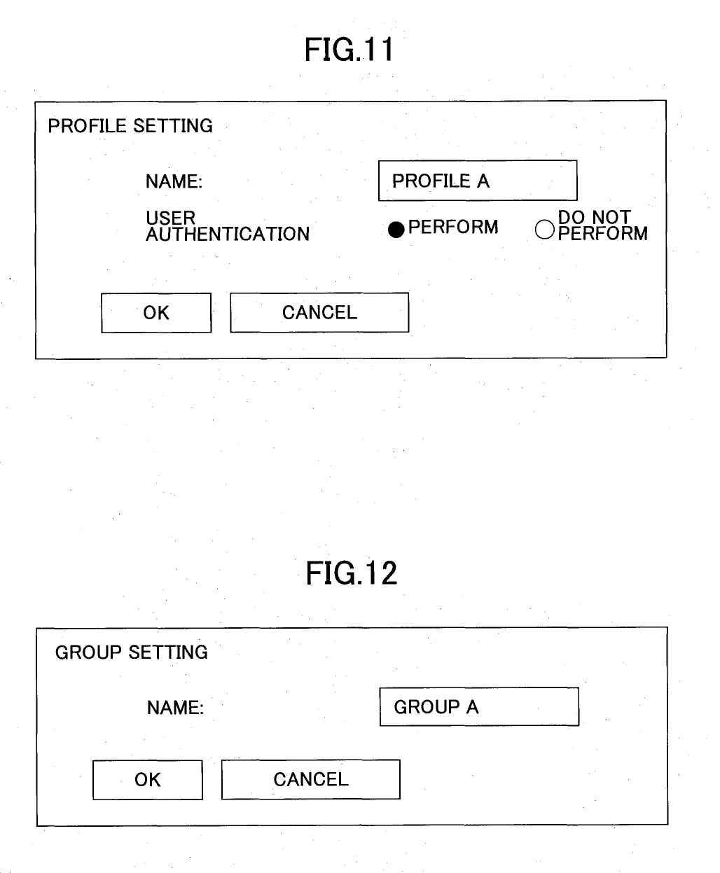

In step S31, the administrator requests to create a profile, from a profile setting screen illustrated in FIG. 11. FIG. 11 is an image diagram of an example of a profile setting screen. The administrator is able to set the name of the profile and whether to perform user authentication, from the profile setting screen, and request the scan application 51 of the service providing system 13 to create a profile. Note that the user authentication set from the profile setting screen is the user authentication performed when the profile is used at the image forming apparatus 11, etc.

In step S32, the scan application 51 stores, in the scan setting storage unit 52, the contents of the profile that has been requested to be created from the user terminal 12. The scan setting storage unit 52 stores the contents of the profile in association with an assigned profile ID, in the profile table. The assigned profile ID is returned to the user terminal 12 via the scan application 51.

In step S33, the administrator requests, from a group setting screen illustrated in FIG. 12, to create a group belonging to the profile of the profile ID that has been reported. FIG. 12 is an image diagram of an example of a group setting screen. The administrator is able to set the name of a group from the group setting screen, and request the scan application 51 to create a group belonging to the profile.

Furthermore, in step S34, the scan application 51 stores the contents of the group that has been requested to be created from the user terminal 12, in the scan setting storage unit 52. The scan setting storage unit 52 stores the contents of the group in association with assigned group ID, in the group table. The assigned group ID is returned to the user terminal 12 via the scan application 51.

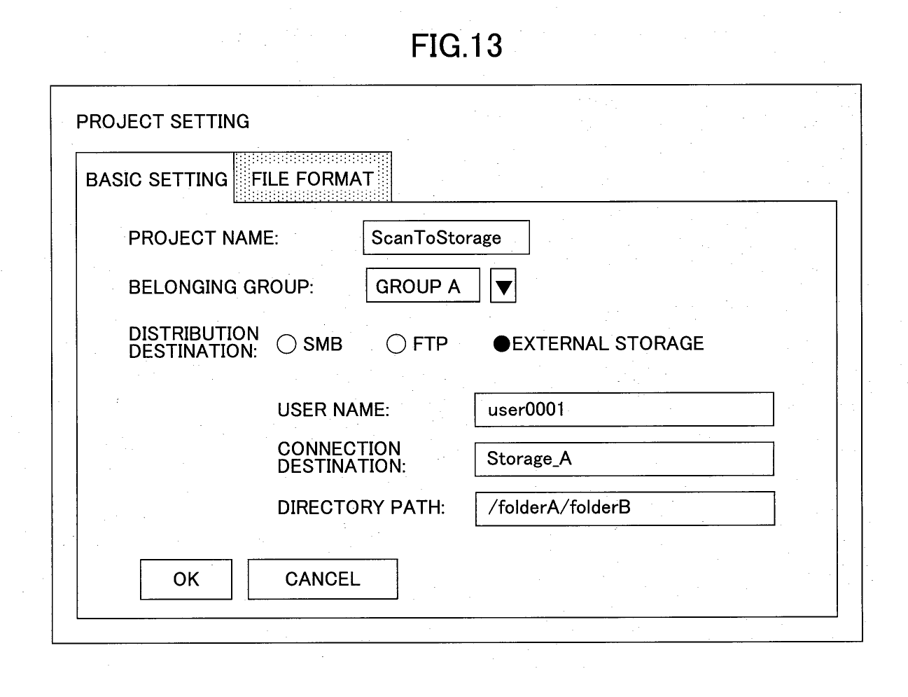

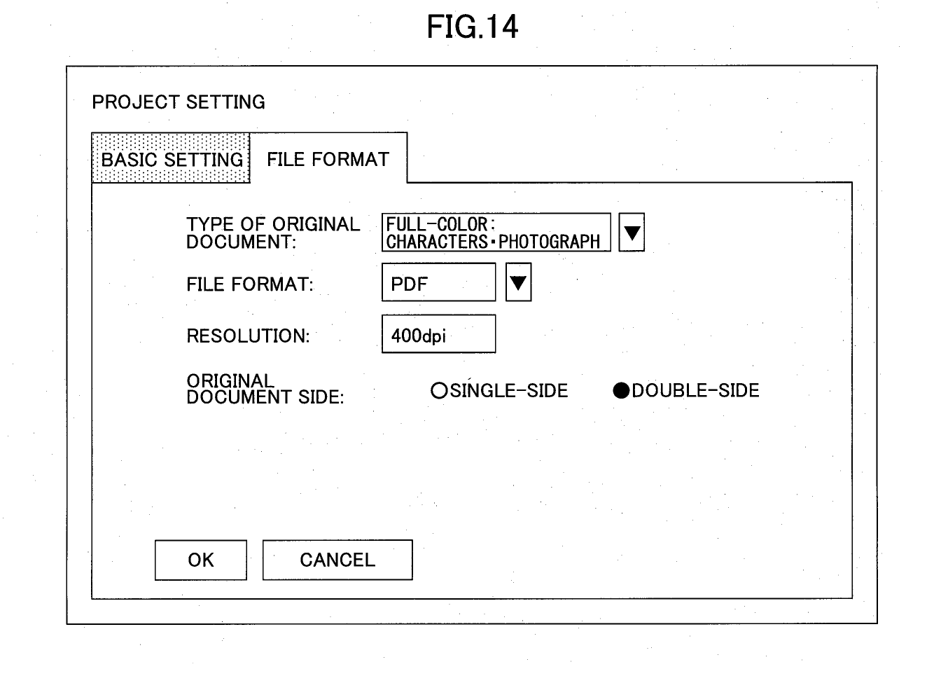

In step S35, the administrator requests, from the project setting screen illustrated in FIGS. 13 and 14, to create a project belonging to the group of the reported group ID. FIG. 13 is an image diagram of an example of a project setting screen for making basic settings; FIG. 14 is an image diagram of an example of a project setting screen for setting a file format, etc.

The administrator is able to set the name of the project, the belonging group, the distribution destination, and the file format, from the project setting screen illustrated in FIGS. 13 and 14, and request the scan application 51 to create a project.

In step S36, the scan application 51 stores, in the scan setting storage unit 52, the contents of the project that has been requested to be created from the user terminal 12. The scan setting storage unit 52 stores the contents of the project in association with the assigned project ID, in the project table. The assigned project ID is returned to the user terminal 12 via the scan application 51.

In step S37, the administrator requests to acquire a list of devices associated with the company ID, which is needed for displaying a profile assignment screen for assigning a profile to an electronic device such as the image forming apparatus 11. In step S38, the scan application 51 requests the company management module 54 to acquire the requested list of devices associated with the company ID.

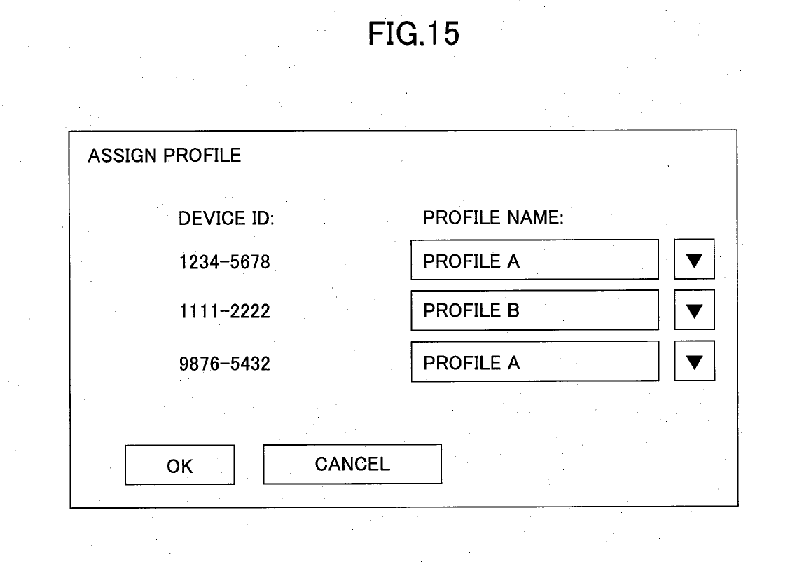

In step S39, the company management module 54 acquires, from the device table of the company information storage unit 56, the requested list of devices associated with the company ID. The company management module 54 returns the list of devices associated with the company ID to the user terminal 12 via the scan application 51. The user terminal 12 receives an association of a profile ID and a device ID from the administrator, by displaying a profile assignment screen as illustrated in FIG. 15 including the acquired list of device IDs.

FIG. 15 is an image diagram of an example of a profile assignment screen. The administrator is able to request the association of an electronic device such as the image forming apparatus 11 with a profile, by using the profile assignment screen. In step S40, the administrator requests the scan application 51 to associate a device ID and a profile ID, from the profile assignment screen.

In step S41, the scan application 51 stores the device ID and the profile ID for which an association has been requested from the administrator, in the device setting table in the scan setting storage unit 52 illustrated in FIG. 6D.

As described above, in the information processing system 1 according to the present embodiment, after the scan setting is completed, the scan setting and an electronic device such as the image forming apparatus 11 are associated with each other. The electronic device such as the image forming apparatus 11 associated with the scan setting is able to perform scanning, according to the associated scan setting. Furthermore, in the information processing system 1 according to the present embodiment, the scan setting and an electronic device such as the image forming apparatus 11 are associated with each other, and therefore when the scan setting is updated, it is possible to identify the electronic device such as the image forming apparatus 11 for which the scan setting needs to be updated.

<<Sequence of Synchronizing Scan Settings>>

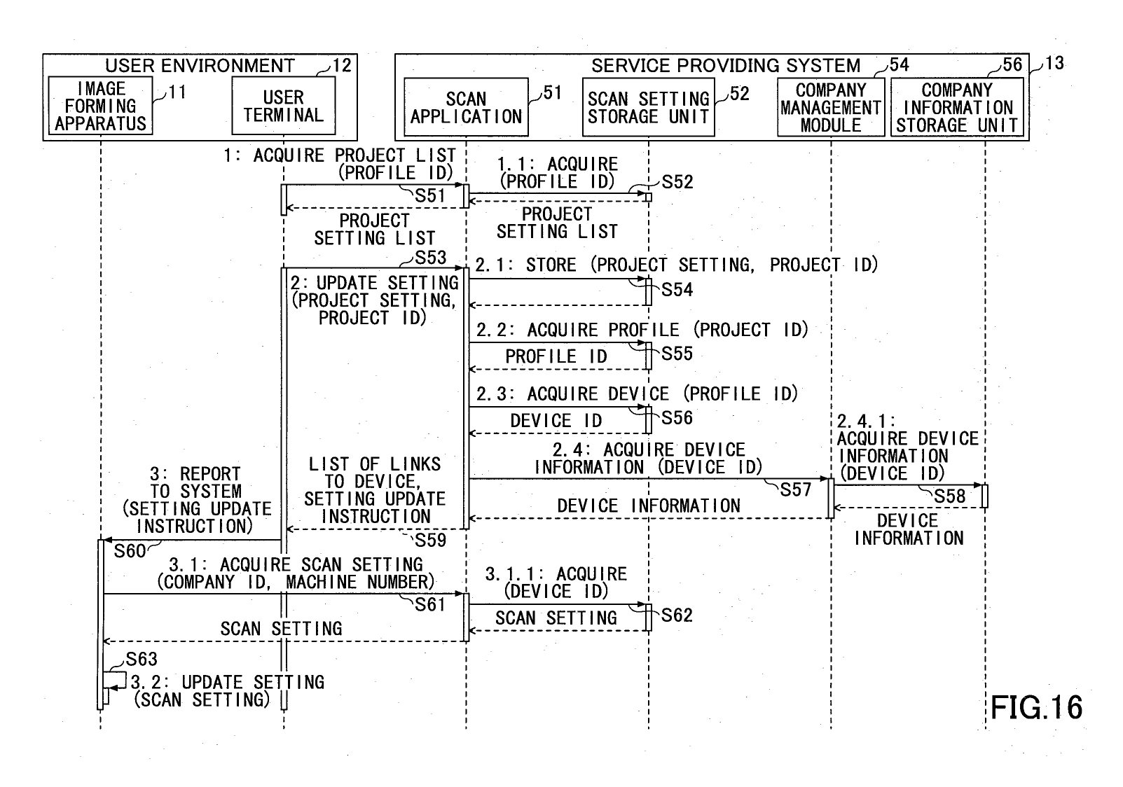

The sequence diagram of FIG. 8 illustrates an example of a process in which the administrator makes a scan setting in the service providing system 13 from the user terminal 12, and applies the scan setting to the image forming apparatus 11. FIG. 16 is a sequence diagram of a process in which the administrator updates the scan setting stored in the service providing system 13 from the user terminal 12, and applies the scan setting to the image forming apparatus 11.

FIG. 16 is a sequence diagram illustrating an example of a process of synchronizing scan settings. In step S51, the administrator operates the user terminal 12, and makes a request to acquire a list of projects associated with the profile ID. In step S52, the scan application 51 acquires, from the scan setting storage unit 52, the requested list of projects associated with the profile ID.

The scan application 51 returns, to the user terminal 12, the acquired list of project settings (for example, scan settings) associated with the profile ID. Then, the web browser 63 of the user terminal 12 displays the list of project settings associated with the profile ID received from the scan application 51.

After viewing the project setting, the administrator instructs the service providing system 13 to update the project setting, from the user terminal 12. In step S53, the user terminal 12 requests the scan application 51 of the service providing system 13 to update the project setting, by specifying the project ID. In step S54, the scan application 51 updates the project setting in the project table identified by the project ID specified by the user terminal 12, by the project setting received from the user terminal 12.

In step S55, the scan application 51 acquires the profile ID associated with the project ID from the scan setting storage unit 52, by specifying the project ID. In step S56, the scan application 51 acquires one or more device IDs associated with the profile ID from the device setting table in the scan setting storage unit 52, by specifying the acquired profile ID.

In step S57, the scan application 51 requests the company management module 54 to provide device information, by specifying the acquired one or more device IDs. In step S58, the company management module 54 acquires device information associated with the device ID from the device table in the company information storage unit 56, by specifying the one or more device IDs. The device information associated with the device ID is returned to the scan application 51 from the company management module 54.

In step S59, the scan application 51 returns, to the user terminal 12, the list of links (for example, an IP address and a path) to the image forming apparatus 11 included in the one or more device information items received from the company management module 54, and a setting update instruction. In step S60, the user terminal 12 sends a setting update instruction to one or more image forming apparatuses 11, by using the list of links to the image forming apparatuses 11.

In step S61, the image forming apparatus 11 requests the service providing system 13 to acquire a scan setting, by specifying the company ID and the machine number, according to the setting update instruction. In step S62, the scan application 51 of the service providing system 13 identifies the profile ID from the device ID corresponding to the company ID and the machine number. The scan application 51 returns, to the image forming apparatus 11, a scan setting that is an example of a project setting associated with the identified profile ID. In step S63, the image forming apparatus 11 updates the scan setting stored in itself with the scan setting returned from the scan application 51 of the service providing system 13.

In the sequence diagram of FIG. 16, the administrator requests the service providing system 13 to update the scan setting, from the user terminal 12. The updating of the scan setting includes, for example, the conversion of the file format such as converting from JPEG to PDF.

When the scan setting is updated, in the service providing system 13, it is possible to identify the image forming apparatus 11 associated with the updated scan setting, from the scan setting storage unit 52. Furthermore, in the service providing system 13, the device information of the identified image forming apparatus 11 can be acquired. This device information includes the link (IP address and path) to the image forming apparatus 11.

The scan application 51 returns, to the user terminal 12, the device information of one or more image forming apparatuses 11 associated with the updated scan setting, and a setting update instruction. The user terminal 12 is able to access the web API 62 of the embedded application 61 operating in the image forming apparatus 11, and send a request for the setting update instruction to the embedded application 61, according to the device information of one or more image forming apparatuses 11.

The image forming apparatus 11 is able to acquire a scan setting from the service providing system 13, according to the requested setting update instruction. Therefore, the image forming apparatus 11 is able to update the scan setting stored in itself by the scan setting returned from the service providing system 13.

Note that the web browser 63 operating in the user terminal 12 may realize, by a script, the process of step S60, of sending the setting update instruction to one or more image forming apparatuses 11 by using a list of links to the image forming apparatuses 11. The script may be received from, for example, the scan application 51, before executing the process of step S60.

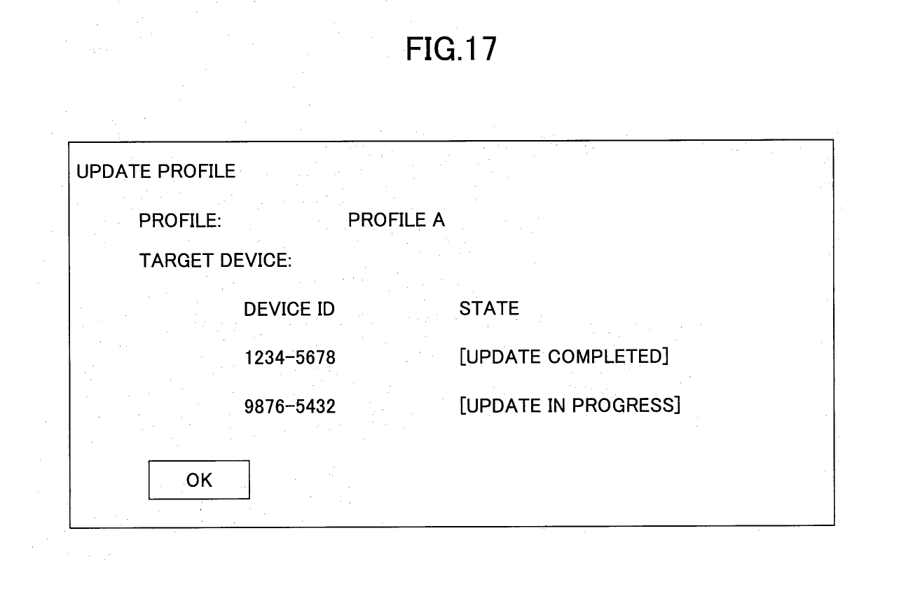

Furthermore, after the administrator instructs the service providing system 13 to update the project setting in step S53, the web browser 63 operating in the user terminal 12 may display a profile update screen as illustrated in FIG. 17. FIG. 17 is an image diagram of an example of a profile update screen. The profile update screen of FIG. 17 expresses an example of displaying the state of the profile update (for example, update completed, update in progress) for each electronic device identified by the device ID.

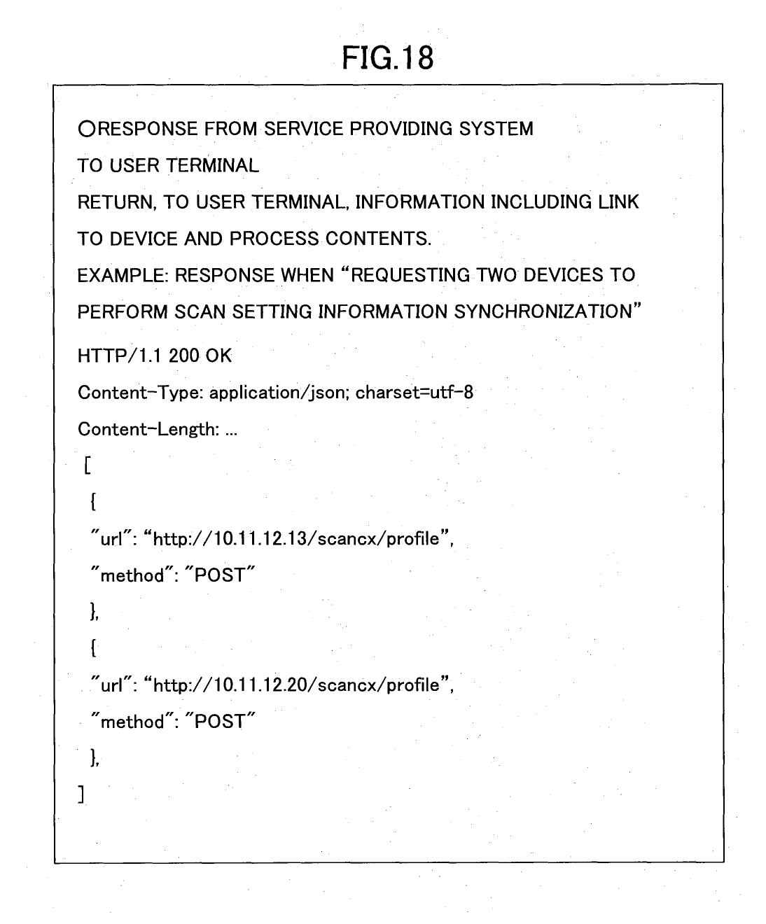

Furthermore, the response from the service providing system 13 to the user terminal 12 in step S59 of FIG. 16, is given by returning information as illustrated in, for example, FIG. 18. FIG. 18 is a configuration diagram of an example of a response from the service providing system 13 to the user terminal 12. The response from the service providing system 13 to the user terminal 12 in step S59 of FIG. 16, includes a link to the electronic device and a process instruction, as information. FIG. 18 illustrates an example of information for requesting two electronic devices to synchronize their scan settings.

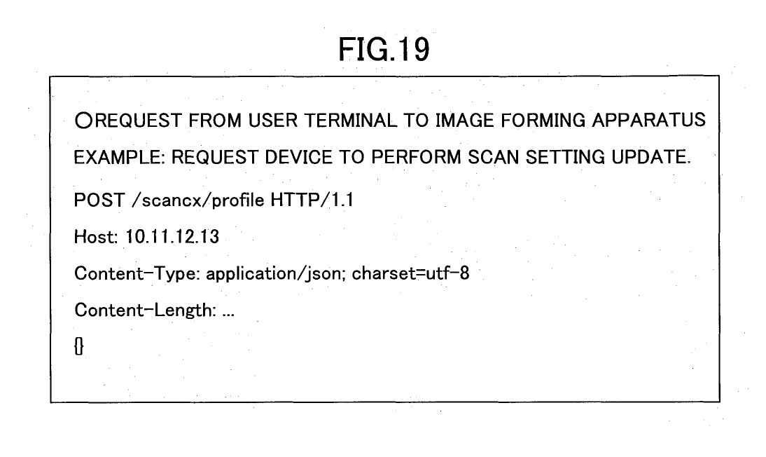

Furthermore, the request from the user terminal 12 to the image forming apparatus 11 in step S60 of FIG. 16, is made by sending information as illustrated in, for example, FIG. 19. FIG. 19 is a configuration diagram of an example of a request from the user terminal 12 to the image forming apparatus 11.

The request from the user terminal 12 to the image forming apparatus 11 in step S60 of FIG. 16 includes a process instruction as information. FIG. 19 illustrates an example of information for requesting electronic devices to synchronize their scan settings.

<<Sequence of Synchronizing Job Log>>

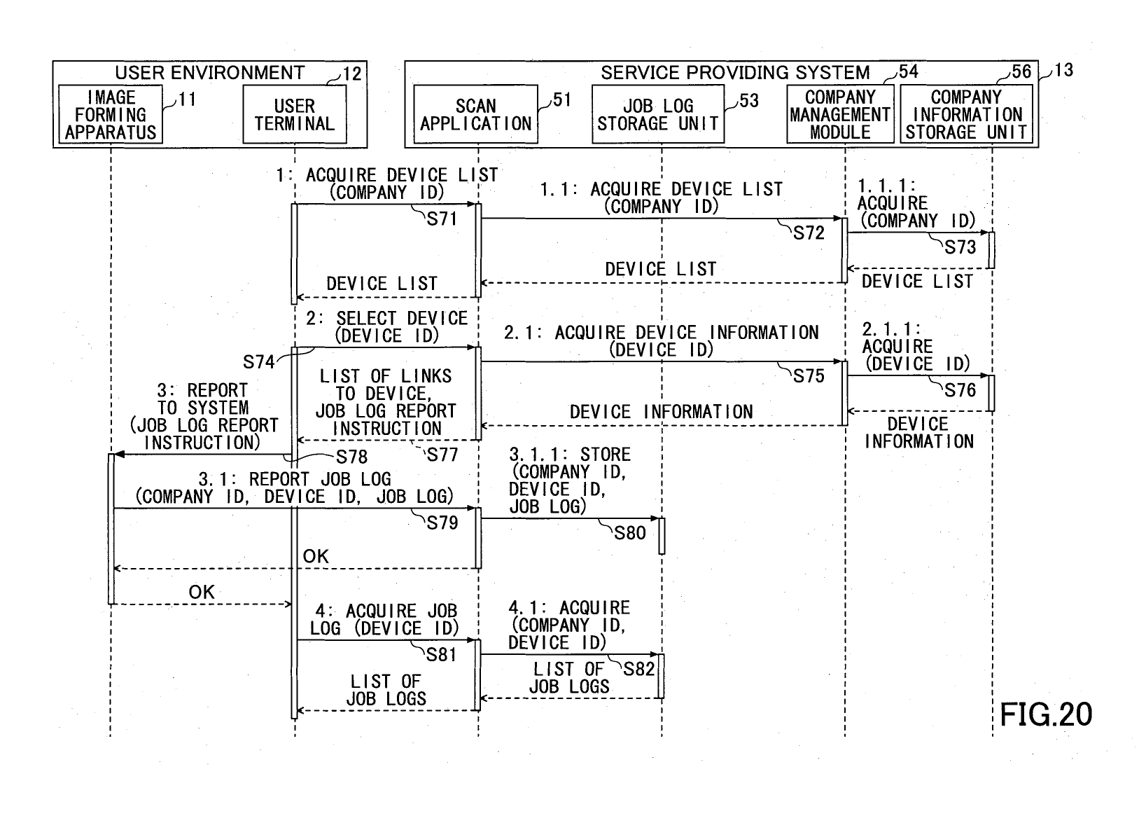

FIG. 20 is a sequence diagram of steps performed until the job log stored in the image forming apparatus 11 is applied to the service providing system 13. FIG. 20 is a sequence diagram illustrating an example of a process of synchronizing job logs.

In step S71, the user operates the user terminal 12, and requests to acquire a list of devices associated with the company ID. In step S72, the scan application 51 requests the company management module 54 to acquire a list of devices associated with the company ID. In step S73, the company management module 54 acquires the requested list of devices associated with the company ID, from the company information storage unit 56.

The company management module 54 returns the list of devices associated with the company ID to the user terminal 12 via the scan application 51. Then, the web browser 63 of the user terminal 12 displays the list of devices associated with the company ID, received from the scan application 51.

After viewing the device list, the user selects, from the user terminal 12, the image forming apparatus 11 that is an example of an electronic device for synchronizing the job log. Note that the user may select a plurality of the electronic devices as electronic devices for synchronizing the job log. In step S74, the user terminal 12 requests the scan application 51 of the service providing system 13 to acquire the device information, by specifying the device ID of the image forming apparatus 11 selected by the user. In step S75, the scan application 51 requests the company management module 54 to acquire the device information associated with the device ID.

In step S76, the company management module 54 acquires, from the company information storage unit 56, the requested device information associated with the device ID. The company management module 54 returns the device information associated with the device ID to the scan application 51.

In step S77, the scan application 51 returns, to the user terminal 12, a list of links (for example, an IP address and a path) to electronic devices such as the image forming apparatuses 11 included in one or more device information items received from the company management module 54, and a job log report instruction. In step S78, the user terminal 12 sends the job log report instruction to the image forming apparatus 11, by using the list of links to the electronic devices such as the image forming apparatuses 11.

In step S79, the image forming apparatus 11 reports the job log to the scan application 51 of the service providing system 13, by specifying the company ID and the device ID, according to the job log report instruction. In step S80, the scan application 51 stores the job log in association with the company ID and the device ID in the job log storage unit 53. When the storing of the job log in the job log storage unit 53 is successful, the scan application 51 returns a message indicating that the job log is successfully stored, to the user terminal 12 via the image forming apparatus 11.

In step S81, the user requests the scan application 51 of the service providing system 13 to acquire the job log, by specifying the device ID of the image forming apparatus 11 that has successfully stored the job log. In step S82, the scan application 51 acquires, from the job log storage unit 53, the list of job logs associated with the company ID and the device ID. The scan application 51 returns, to the user terminal 12, the list of job logs associated with the company ID and the device ID.

FIG. 20 illustrates an example where the user terminal 12 acquires a job log from the service providing system 13, after applying the job log stored in the image forming apparatus 11 to the service providing system 13.

Note that in the information processing system 1, the process of applying the job log to the service providing system 13 from the image forming apparatus 11, and the process where the user terminal 12 acquires the job log from the user terminal 12, may be performed in an asynchronous manner. In this case, step S80 and onward in the sequence diagram of FIG. 20 are omitted.

In the sequence diagram of FIG. 20, the user selects, from a device list, the electronic device for synchronizing the job log. A plurality of electronic devices may be selected from the device list. When an electronic device is selected from the device list, it is possible to identify the device information associated with the selected electronic device at the service providing system 13.

The scan application 51 of the service providing system 13 returns, to the user terminal 12, device information associated with the selected electronic device and the job log report instruction. The user terminal 12 is able to access the web API 62 of the embedded application 61 operating in the image forming apparatus 11, and send a request for the job log report instruction to the embedded application 61, according to device information of one or more of the image forming apparatuses 11. The embedded application 61 of the image forming apparatus 11 is able to report the job log to the service providing system 13, according to the requested job log report instruction.

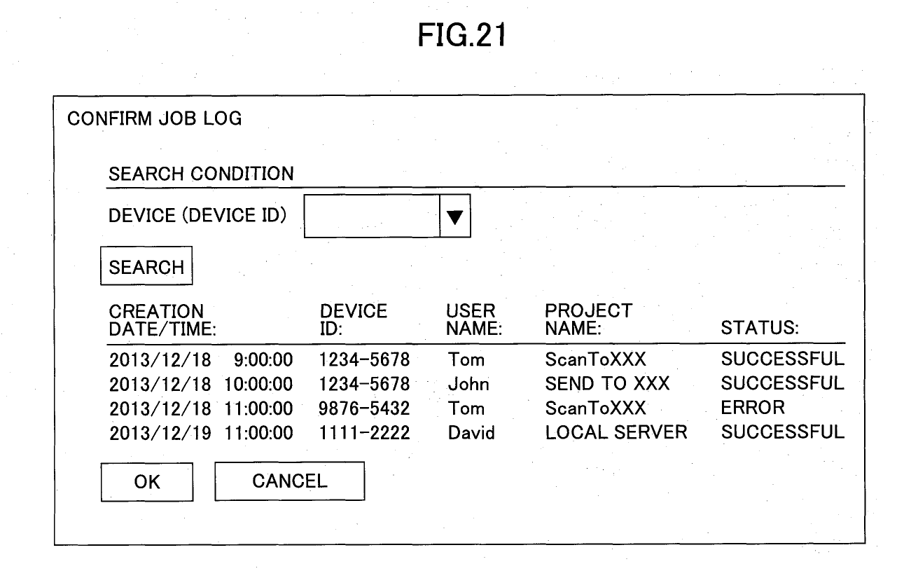

Note that in the sequence diagram of FIG. 20, after a job log is reported according to the job log report instruction, the user terminal 12 acquires the job log list from the service providing system 13. By rendering the job log view screen as illustrated in FIG. 21 again, by the acquired job log list, the user terminal 12 is able to display the latest job log of the image forming apparatus 11.

FIG. 21 is an image diagram of an example of the job log view screen. The job log view screen of FIG. 21 illustrates an example in which the job log list, which is acquired from the service providing system 13 by the user terminal 12, is displayed. Note that in the job log view screen of FIG. 21, a creation date/time, a device ID, a user name, project name, and a status, are displayed for each job log.

<<Sequence of Registering License>>

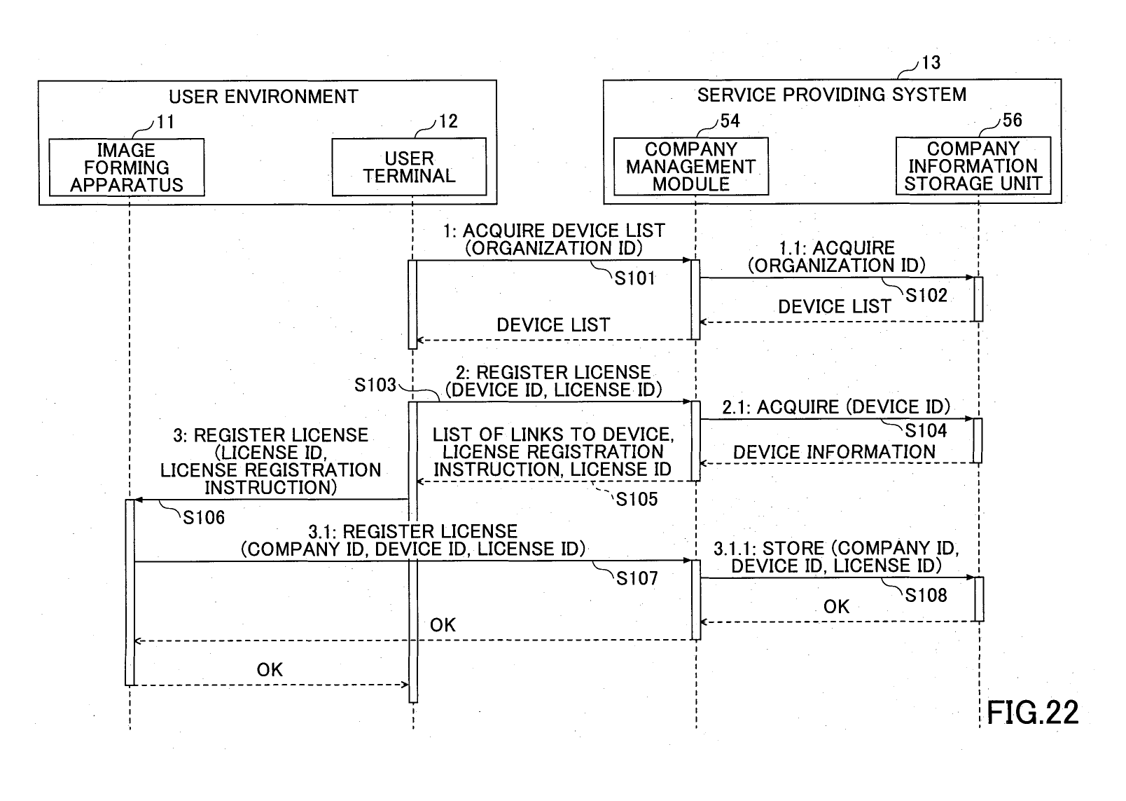

The sequence diagrams of FIGS. 16 and 20 illustrate a process of sending, from the service providing system 13 to the user terminal 12, the link to an electronic device such as the image forming apparatus 11, and a process instruction such as a setting update instruction and a job log report instruction. FIG. 22 is a sequence diagram of a process of sending, from the service providing system 13 to the user terminal 12, a link to an electronic device, a license registration instruction that is an example of a process instruction, and a license ID that is an example of information needed for the process according to the process instruction.

FIG. 22 is a sequence diagram illustrating an example of a process of registering a license. In step S101, the administrator operates the user terminal 12, and requests to acquire a list of devices associated with the company ID. In step S102, the company management module 54 acquires the requested list of devices associated with the company ID, from the company information storage unit 56, and returns the list to the user terminal 12. Then, the web browser 63 of the user terminal 12 displays the list of devices associated with the company ID received from the company management module 54.

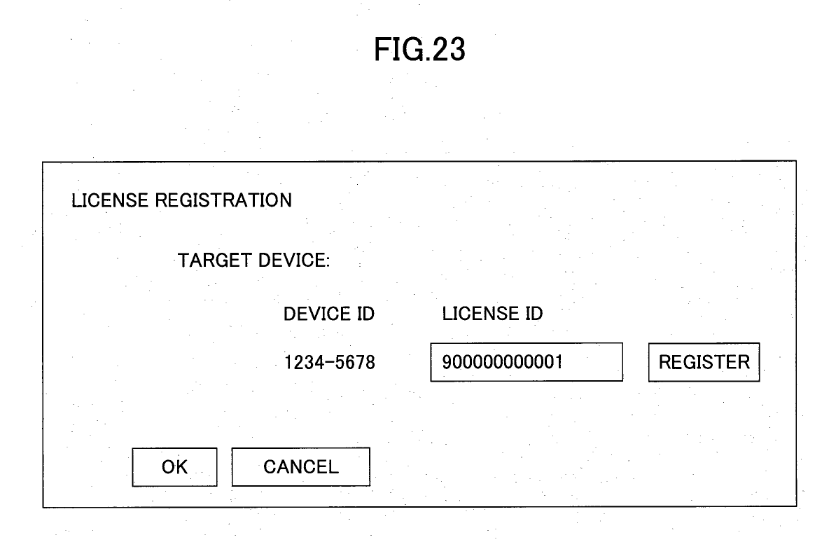

The administrator selects, from the list of devices associated with the company ID, an image forming apparatus 11 that is an example of an electronic device for registering a license from the user terminal 12. For example, the user terminal 12 displays a license registration screen as illustrated in FIG. 23, and prompts the administrator to input license ID. FIG. 23 is an image diagram of an example of a license registration screen. Note that the license ID is issued, for example, at the time of closing a contract between the administrator and the provider of the service providing system 13.

The license registration screen of FIG. 23 includes the device ID of the image forming apparatus 11 that the administrator selected from the list of devices associated with the company ID, and an input field of a license ID to be used when registering the license of the device ID. The administrator is able to instruct performing license registration, by operating the user terminal 12, inputting the license ID in the license registration screen of FIG. 23, and pressing the OK button.

In step S103, the user terminal 12 requests the service providing system 13 to perform license registration, by specifying the device ID and the license ID. In step S104, the company management module 54 of the service providing system 13 acquires device information associated with the device ID, from the company information storage unit 56.

In step S105, the company management module 54 returns, to the user terminal 12, the link to the image forming apparatus 11 included in the device information acquired from the company information storage unit 56, a license registration instruction, and the license ID. Note that when the administrator has selected a plurality of the electronic devices from the list of devices associated with the company ID, in step S105, the link to the image forming apparatus 11 returned to the user terminal 12 in step S105, becomes a list of links to the electronic devices.

In step S106, the user terminal 12 sends the license registration instruction and the license ID to the image forming apparatus 11, by using a link to the image forming apparatus 11. In step S107, the image forming apparatus 11 requests the company management module 54 of the service providing system 13 to perform license registration, by specifying a company ID, a device ID, and a license ID, according to the license registration instruction.

In step S108, the company management module 54 stores the license ID in association with the company ID and the device ID, in the company information storage unit 56. When the license registration is successful, the company management module 54 reports to the user terminal 12 that the license registration is successful, via the image forming apparatus 11.

The electronic device such, as the image forming apparatus 11 that uses the service providing system 13, first needs to perform license registration. The sequence diagram of FIG. 22 illustrates a process of performing license registration of the image forming apparatus 11 that uses the service providing system 13. In FIG. 22, the administrator selects the electronic device for performing license registration, from the device list. A plurality of the electronic devices may be selected from the device list. The administrator inputs the license ID used for the license registration of the selected electronic device. The service providing system 13 identifies the device information associated with the electronic device for performing license registration, and returns, to the user terminal 12, the link to the electronic device, the license registration instruction, and the license ID. Then, the user terminal 12 is able to access the electronic device based on the link to the electronic device, and request the electronic device to perform the process of performing license registration for which the license ID has been specified.

<<Sequence of Synchronizing Scan Setting by Distributing Scan Setting>>

In the sequence diagram of FIG. 16, the user terminal 12 receives, from the service providing system 13, a link to the electronic device, and a setting update instruction that is an instruction of a process to be performed by the electronic device; and then the user terminal 12 sends the setting update instruction to the electronic device.

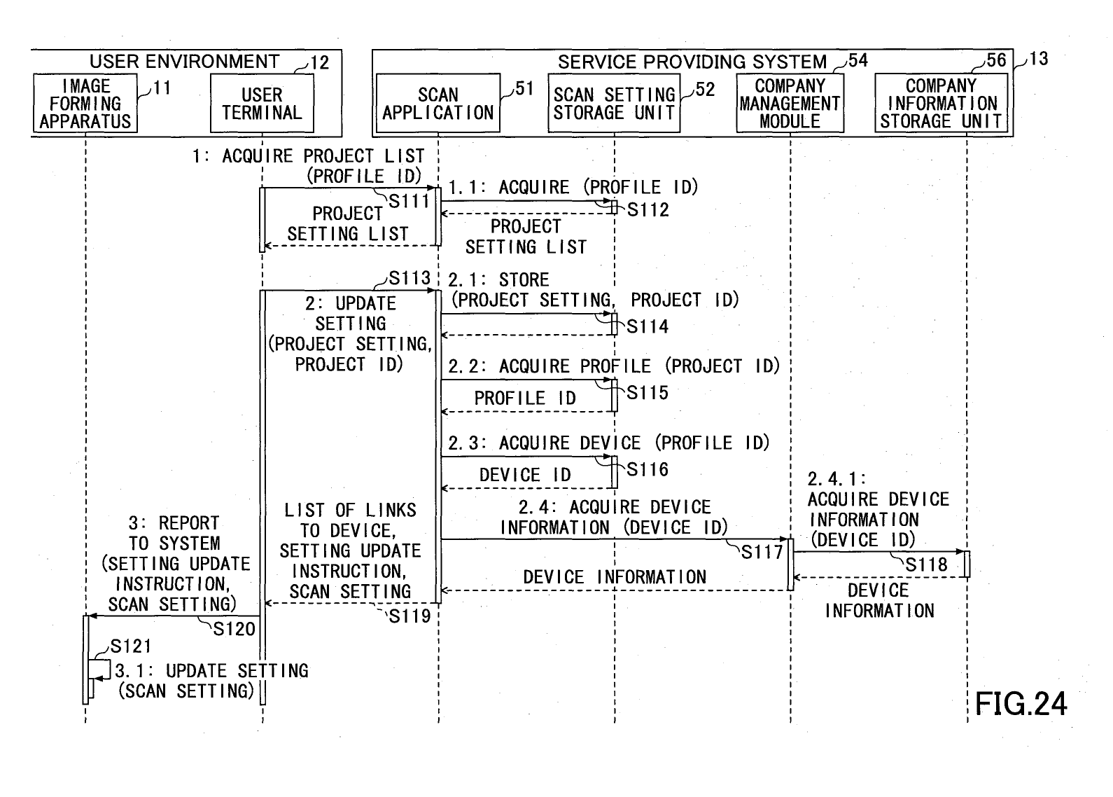

FIG. 24 is a sequence diagram of a process of receiving, from the service providing system 13, a link to the electronic device, a setting update instruction, and a scan setting that is information associated with a process, and sending the setting update instruction and the scan setting to the electronic device. In the sequence diagram of FIG. 24, the image forming apparatus 11 receives a scan setting from the user terminal 12, and therefore the scan setting can be synchronized with the scan setting of the service providing system 13, without the need of the image forming apparatus 11 to access the service providing system 13.

FIG. 24 is a sequence diagram illustrating another example of a process of synchronizing the scan setting. The processes of steps S111 through S118 are the same as the processes of steps S51 through S58 of FIG. 16, and therefore descriptions thereof are omitted.

In step S119, the scan application 51 returns, to the user terminal 12, the link to the image forming apparatus 11 included in the device information received from the company management module 54, the setting update instruction, and the scan setting. In step S120, the user terminal 12 sends the setting update instruction and the scan setting to the image forming apparatus 11, by using the link to the image forming apparatus 11. In step S121, the image forming apparatus 11 updates the scan setting stored in itself with the scan setting sent from the user terminal 12, according to the setting update instruction.

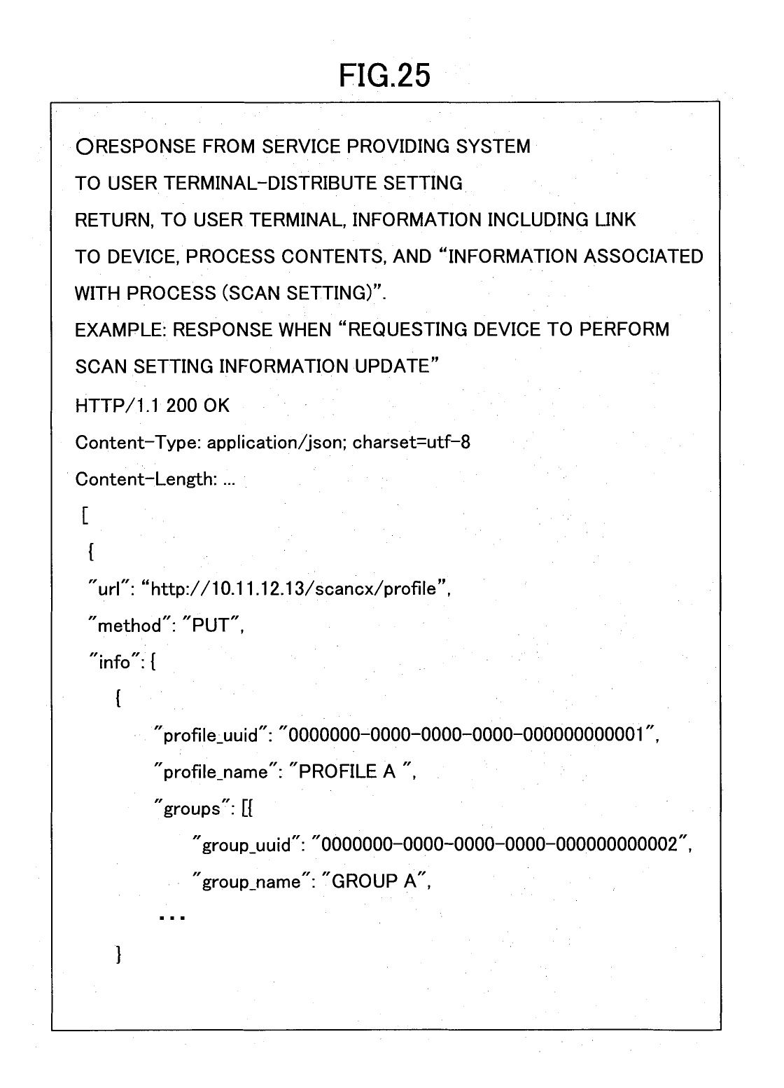

Furthermore, the response from the service providing system 13 to the user terminal 12 in step S119 of FIG. 24, is given by returning information, for example, as illustrated in FIG. 25. FIG. 25 is a configuration diagram of an example of a response from the service providing system 13 to the user terminal 12. The response from the service providing system 13 to the user terminal 12 of step S119 in FIG. 24 includes a link to the electronic device, a process instruction (process contents), and a scan setting (information associated with process), as information. FIG. 25 illustrates an example of information for requesting to update the scan setting to one electronic device.

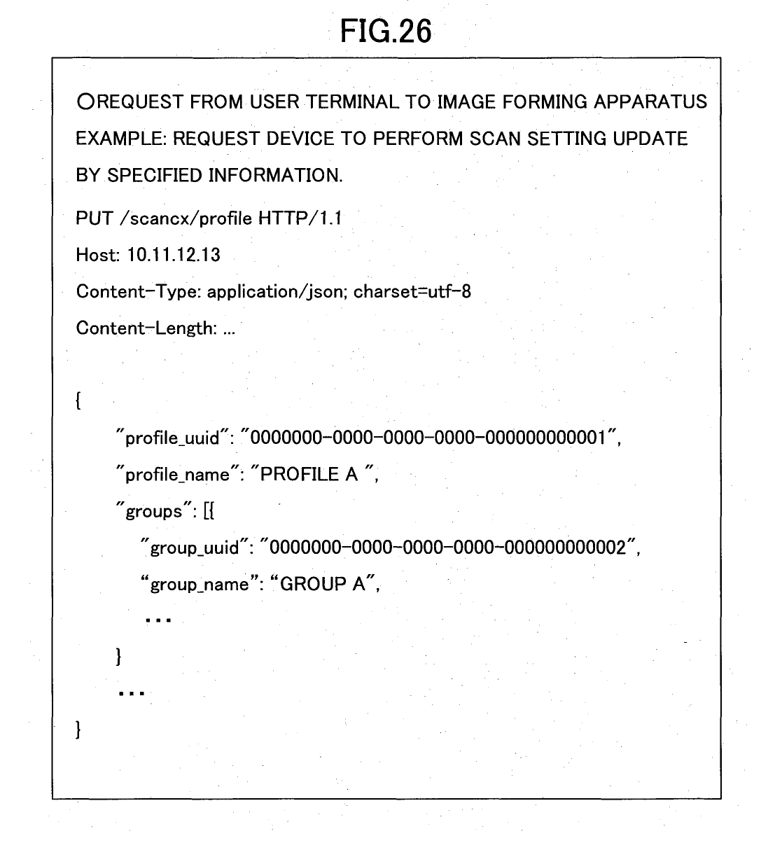

Furthermore, the request from the user terminal 12 to the image forming apparatus 11 in step S120 of FIG. 24 is given by returning information, for example, as illustrated in FIG. 26. FIG. 26 is a configuration diagram of an example of a request from the user terminal 12 to the image forming apparatus 11. The request from the user terminal 12 to the image forming apparatus 11 in step S120 of FIG. 24 includes the process instruction and the scan setting, as information. FIG. 24 illustrates an example of information for requesting the electronic device to update the scan setting.

### (Overview)

In the information processing system 1 according to the present embodiment, a link to an electronic device present in, for example, an intranet, is stored in the service providing system 13 by providing device information to the service providing system 13 when performing device registration of the electronic device in the service providing system 13. The user terminal 12 is present in the same intranet as that of the electronic device, and therefore it is assumed that the user terminal 12 is able to access the electronic device.

When the administrator or the user performs information operations (scan setting update, job log report, etc.) by using the service providing system 13, the service providing system 13 identifies the electronic device relevant to the information operations, and returns, to the user terminal 12, a link to the electronic device and a process instruction. The user terminal 12 gives the process instruction to the electronic device by using the link to the electronic device.

The electronic device is able to access the service providing system 13 and synchronize the scan setting and report the job log, according to the process instruction. In the case of synchronizing the scan setting, by referring to the data of the service providing system 13 that is the master data, the user terminal 12 is able to match the data, even if an operation of scan setting update is made from a plurality of the user terminals 12. Furthermore, in the case of reporting a job log, by updating the data of the service providing system 13 that is the master data, the user terminal 12 is able to match the data, even if an operation of reporting a job log is made from a plurality of the user terminals 12.

Furthermore, the service providing system 13 returns information associated with the process to the user terminal 12, in addition to the link to the electronic device and the process instruction. The user terminal 12 is able to send, to the electronic device, the process instruction and information associated with the process, by using the link to the electronic device. The electronic device is able to execute a process instruction by using the information associated with the process. For example, the electronic device is able to synchronize the scan setting stored in itself with the scan setting of the service providing system 13, by using the scan setting that is an example of information associated with the process received from the user terminal 12, without accessing the service providing system 13.

As described above, according to the information processing system 1 according to the present embodiment, when the administrator or the user sends a process request to the service providing system 13 from the user terminal 12, a link to the electronic device relevant to the process can be identified at the service providing system 13. The user terminal 12 receives the link to the electronic device and an instruction for a process from the service providing system 13, and the user terminal 12 is able to instruct the electronic device to perform the process by using the received link to the electronic device. The electronic device is able to access the service providing system 13 if access is necessary, and perform the process, based on the instruction for the process from the user terminal 12.

As described above, in the information processing system 1 according to the present embodiment, it is possible to instruct an electronic device to change a setting when a change is made in the setting in the service providing system 13, without inquiring whether there is a setting change by polling the service providing system 13 from the electronic device. The information processing system 1 according to the present embodiment does not perform polling, and therefore it is possible to reduce the time taken until the changed setting is applied the electronic device, without increasing the network load.

The information processing system and the information processing method are not limited to the specific embodiments described herein, and variations and modifications may be made without departing from the scope of the present invention. Note that the scan application 51 and the company management module 54 are examples of an information operating unit. The embedded application 61 of the image forming apparatus 11 is an example of an information processing unit. A link to the electronic device is an example of connection information to the electronic device. The setting update instruction of FIG. 16 is an example of an update instruction. The job log report instruction is an example of a report instruction. The license ID of FIG. 22 and the scan setting of FIG. 24 are examples of information associated with a process. The license registration instruction is an example of a registration instruction. The setting update instruction of FIG. 24 is an example of an update instruction.

According to one embodiment of the present invention, an information processing system and an information processing method are provided, by which an instruction for a process can be given from a service providing system to an electronic device.

The present application is based on and claims the benefit of priority of Japanese Priority Patent Application No. 2014-054035, filed on Mar. 17, 2014, the entire contents of which are hereby incorporated herein by reference.

1. An information processing system including a plurality of electronic devices and a service providing system constituted by one or more information processing devices, the information processing system comprising:
an information operating unit configured to send, from the service providing system to a user terminal, connection information for connecting to one of the plurality of electronic devices relevant to a request for a predetermined information operation, and a process instruction for causing the one of the plurality of electronic devices to execute a process based on the request for the predetermined information operation, when the request for the predetermined information operation is received by the service providing system from the user terminal; and
an information processing unit configured to perform a process of synchronizing information at the one of the plurality of electronic devices by accessing the service providing system according to the process instruction from the user terminal, when the user terminal sends the process instruction, which has been sent by the information operating unit, to the one of the plurality of electronic devices based on the connection information sent by the information operating unit.

2. The information processing system according to claim 1, wherein
the information processing unit accesses the service providing system according to an update instruction from the user terminal, and updates information stored in the information processing unit itself by information corresponding to the update instruction acquired from the service providing system.

3. The information processing system according to claim 1, wherein
the information processing unit accesses the service providing system according to a report instruction from the user terminal, reports information corresponding to the report instruction to the service providing system, and causes the service providing system to store the reported information.

4. An information processing system including a plurality of electronic devices and a service providing system constituted by one or more information processing devices, the information processing system comprising:
an information operating unit configured to send, from the service providing system to a user terminal, connection information for connecting to one of the plurality of electronic devices relevant to a request for a predetermined information operation, a process instruction for causing the one of the plurality of electronic devices to execute a process based on the request for the predetermined information operation, and association information associated with the process, when the request for the predetermined information operation is received by the service providing system from the user terminal; and
an information processing unit configured to perform a process at the one of the plurality of electronic devices according to the process instruction by using the association information, when the user terminal sends the process instruction and the association information, which have been sent by the information operating unit, to the one of the plurality of electronic devices based on the connection information sent by the information operating unit.

5. The information processing system according to claim 4, wherein
the information processing unit accesses the service providing system according to a registration instruction from the user terminal, reports the association information to the service providing system, and registers information.

6. The information processing system according to claim 4, wherein
the information processing unit updates information stored in the information processing unit itself by the association information, according to an update instruction from the user terminal.

7. An information processing method executed by an information processing system including a plurality of electronic devices, and a service providing system constituted by one or more information processing devices, the information processing method comprising:
sending, from the service providing system to a user terminal, connection information for connecting to one of the plurality of electronic devices relevant to a request for a predetermined information operation, and a process instruction for causing the one of the plurality of electronic devices to execute a process based on the request for the predetermined information operation, when the request for the predetermined information operation is received by the service providing system from the user terminal; and
performing a process of synchronizing information at the one of the plurality of electronic devices by accessing the service providing system according to the process instruction from the user terminal, when the user terminal sends the process instruction, which has been sent at the sending, to the one of the plurality of electronic devices based on the connection information sent at the sending.
